(19) United States
(12) Patent Application Publication
(10) Pub. No.: US 2023/0419467 A1
(43) Pub. Date: Dec. 28, 2023

(54) A MOBILE ROBOT SYSTEM FOR AUTOMATED ASSET INSPECTION

(71) Applicant: Boston Dynamics, Inc., Waltham, MA (US)

(72) Inventors: Alex Rice, Arlington, MA (US); Gordon Finnie, III, Newton, MA (US); Marco da Silva, Arlington, MA (US); Christopher Bentzel, Quincy, MA (US); Christopher Allum, Lexington, MA (US); Justine Roy, Waltham, MA (US); Karl Parks, Providence, RI (US)

(73) Assignee: Boston Dynamics, Inc., Waltham, MA (US)

(21) Appl. No.: 18/338,582

(22) Filed: Jun. 21, 2023

Related U.S. Application Data
(60) Provisional application No. 63/354,863, filed on Jun. 23, 2022.

(51) Int. Cl. G06T 7/00; B25J 19/02; B25J 11/00; G01J 5/10; G06V 10/25; G06V 20/50

(52) U.S. Cl. CPC G06T 7/0002; B25J 19/023; B25J 11/00; G01J 5/10; G06V 10/25; G06V 20/50; G01J 2005/0077

(57) ABSTRACT

Methods and apparatus for performing automated inspection of one or more assets in an environment using a mobile robot are provided. The method, comprises defining, within an image captured by a sensor of a robot, a region of interest that includes an asset in an environment of the robot, wherein the asset is associated with an asset identifier, configuring at least one parameter of a computer vision model based on the asset identifier, processing image data within the region of interest using the computer vision model to determine whether an alert should be generated, and outputting the alert when it is determined that the alert should be generated.

### RELATED APPLICATIONS

This application claims the benefit under 35 U.S.C. § 119(e) of U.S. Provisional Patent Application Ser. No. 63/354,863, filed Jun. 23, 2022, and entitled, “A MOBILE ROBOT SYSTEM FOR AUTOMATED ASSET INSPECTION,” the entire contents of which is incorporated herein by reference.

### BACKGROUND

A robot is generally a reprogrammable and multifunctional manipulator, often designed to move material, parts, tools, or specialized devices through variable programmed motions for performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

In some embodiments, a method is provided. The method comprises defining, within an image captured by a sensor of a robot, a region of interest that includes an asset in an environment of the robot, wherein the asset is associated with an asset identifier, configuring at least one parameter of a computer vision model based on the asset identifier, processing image data within the region of interest using the computer vision model to determine whether an alert should be generated, and outputting the alert when it is determined that the alert should be generated.

In one aspect, defining the region of interest comprises defining the region of interest using asset information stored in a data structure associated with a mission recording. In one aspect, the data structure is associated with an action of capturing the image at a first waypoint indicated in the mission recording, and the asset identifier is included in the data structure. In one aspect, the data structure includes the at least one parameter of the computer vision model.

In one aspect, the image captured by the sensor of the robot is a thermal image. In one aspect, the at least one parameter of the computer vision model comprises a temperature threshold. In one aspect, processing image data within the region of interest using the computer vision model to determine whether an alert should be generated comprises: determining a temperature of the asset based on an analysis of the thermal image within the region of interest, comparing the determined temperature of the asset to the temperature threshold, and determining to generate an alert when the determined temperature meets or exceeds the temperature threshold.

In one aspect, the at least one parameter of the computer vision model comprises one or more of a pressure threshold, a vibration threshold, or a radiation threshold. In one aspect, outputting the alert comprises displaying a representation of the image annotated with an indication of the alert on a display. In one aspect, outputting the alert comprises sending a message via at least one network to a computing device, the message including the alert. In one aspect, the method further comprises storing, on at least one storage device, the image and metadata indicating the asset identifier.

In one aspect, the region of interest is a first region of interest that includes a first asset, the method further comprising defining, within the image, a second region of interest that includes a second asset in the environment of the robot, and processing image data within the region of interest using the computer vision model to determine whether the alert should be generated, comprises processing image data within the first region of interest using the computer vision model to determine a first result, processing image data within the second region of interest using the computer vision model to determine a second result, and determining whether the alert should be generated based, at least in part, on the first result and the second result.

In one aspect, the method further comprises for each of a plurality of images captured over time and having the region of interest defined therein, processing image data for the image within the region of interest using the computer vision model to determine at least one quantity associated with the asset, and generating, based on the determined at least one quantity associated with the asset for the plurality of images, a trend analysis for the at least one quantity. In one aspect, the at least one quantity includes one or more of a temperature, a pressure, a vibration, and a radiation amount. In one aspect, the method further comprises providing on a user interface, an indication of the trend analysis for the at least one quantity. In one aspect, the method further comprises generating the alert based, at least in part, on the trend analysis.

In some embodiments, a robot is provided. The robot comprises a perception system including an image sensor configured to capture an image, and at least one computer processor. The at least one processor is configured to define, within an image captured by the image sensor, a region of interest that includes an asset in an environment of the robot, wherein the asset is associated with an asset identifier, configure at least one parameter of a computer vision model based on the asset identifier, process image data within the region of interest using the computer vision model to determine whether an alert should be generated, and output the alert when it is determined that the alert should be generated.

In one aspect, defining the region of interest comprises defining the region of interest using asset information stored in a data structure associated with a mission recording. In one aspect, the data structure is associated with an action of capturing the image at a first waypoint indicated in the mission recording, and the asset identifier is included in the data structure. In one aspect, the data structure includes the at least one parameter of the computer vision model.

In one aspect, the image captured by the image sensor of the robot is a thermal image. In one aspect, the at least one parameter of the computer vision model comprises a temperature threshold. In one aspect, processing image data within the region of interest using the computer vision model to determine whether an alert should be generated comprises determining a temperature of the asset based on an analysis of the thermal image within the region of interest, comparing the determined temperature of the asset to the temperature threshold, and determining to generate an alert when the determined temperature meets or exceeds the temperature threshold.

In one aspect, the at least one parameter of the computer vision model comprises one or more of a pressure threshold, a vibration threshold, or a radiation threshold. In one aspect, outputting the alert comprises displaying a representation of the image annotated with an indication of the alert on a display. In one aspect, outputting the alert comprises sending a message via at least one network to a computing device, the message including the alert. In one aspect, the at least one computer processor is further configured to store, on at least one storage device, the image and metadata indicating the asset identifier. In one aspect, the region of interest is a first region of interest that includes a first asset, and the at least one computer processor is further configured to define, within the image, a second region of interest that includes a second asset in the environment of the robot, wherein processing image data within the region of interest using the computer vision model to determine whether the alert should be generated, comprises processing image data within the first region of interest using the computer vision model to determine a first result, processing image data within the second region of interest using the computer vision model to determine a second result, and determining whether the alert should be generated based, at least in part, on the first result and the second result.

In one aspect, the at least one computer processor is further configured to for each of a plurality of images captured over time and having the region of interest defined therein, process image data for the image within the region of interest using the computer vision model to determine at least one quantity associated with the asset, and generate, based on the determined at least one quantity associated with the asset for the plurality of images, a trend analysis for the at least one quantity. In one aspect, the at least one quantity includes one or more of a temperature, a pressure, a vibration, and a radiation amount. In one aspect, the at least one computer processor is further configured to provide on a user interface, an indication of the trend analysis for the at least one quantity. In one aspect, the at least one computer processor is further configured to generate the alert based, at least in part, on the trend analysis.

In some embodiments, a non-transitory computer readable medium encoded with a plurality of instructions that, when executed by at least one computer processor perform a method is provided. The method comprises defining, within an image captured by a sensor of a robot, a region of interest that includes an asset in an environment of the robot, wherein the asset is associated with an asset identifier, configuring at least one parameter of a computer vision model based on the asset identifier, processing image data within the region of interest using the computer vision model to determine whether an alert should be generated, and outputting the alert when it is determined that the alert should be generated.

In one aspect, defining the region of interest comprises defining the region of interest using asset information stored in a data structure associated with a mission recording. In one aspect, the data structure is associated with an action of capturing the image at a first waypoint indicated in the mission recording, and the asset identifier is included in the data structure. In one aspect, the data structure includes the at least one parameter of the computer vision model.

In one aspect, the image captured by the sensor of the robot is a thermal image. In one aspect, the at least one parameter of the computer vision model comprises a temperature threshold. In one aspect, processing image data within the region of interest using the computer vision model to determine whether an alert should be generated comprises determining a temperature of the asset based on an analysis of the thermal image within the region of interest, comparing the determined temperature of the asset to the temperature threshold, and determining to generate an alert when the determined temperature meets or exceeds the temperature threshold.

In one aspect, the at least one parameter of the computer vision model comprises one or more of a pressure threshold, a vibration threshold, or a radiation threshold. In one aspect, outputting the alert comprises displaying a representation of the image annotated with an indication of the alert on a display. In one aspect, outputting the alert comprises sending a message via at least one network to a computing device, the message including the alert. In one aspect, the method further comprises storing, on at least one storage device, the image and metadata indicating the asset identifier. In one aspect, the region of interest is a first region of interest that includes a first asset, the method further comprising defining, within the image, a second region of interest that includes a second asset in the environment of the robot, wherein processing image data within the region of interest using the computer vision model to determine whether the alert should be generated, comprises processing image data within the first region of interest using the computer vision model to determine a first result, processing image data within the second region of interest using the computer vision model to determine a second result, and determining whether the alert should be generated based, at least in part, on the first result and the second result.

In one aspect, the method further comprises for each of a plurality of images captured over time and having the region of interest defined therein, processing image data for the image within the region of interest using the computer vision model to determine at least one quantity associated with the asset, and generating, based on the determined at least one quantity associated with the asset for the plurality of images, a trend analysis for the at least one quantity. In one aspect, the at least one quantity includes one or more of a temperature, a pressure, a vibration, and a radiation amount. In one aspect, the method further comprises providing on a user interface, an indication of the trend analysis for the at least one quantity. In one aspect, the method further comprises generating the alert based, at least in part, on the trend analysis.

In some embodiments, a method is provided. The method, comprises navigating a mobile robot to traverse a route through an environment, generating, during navigation of the mobile robot along the route, a mission recording that includes a plurality of waypoints and edges connecting pairs of the plurality of waypoints, receiving, via a user interface, a first input from a user, the first input instructing the mobile robot to perform a first action by recording first sensor data at a first waypoint of the plurality of waypoints, receiving, via the user interface, a second input from the user identifying a first asset within the first sensor data captured by a mobile robot at the first waypoint, and associating a first asset identifier with the first action in the mission recording, wherein the first asset identifier uniquely identifies the first asset in the environment.

In one aspect, the method further comprises instructing the mobile robot to execute a first mission corresponding to the mission recording, automatically capturing second sensor data when the mobile robot reaches the first waypoint along the route, and automatically storing, on at least one storage device, the asset identifier as metadata associated with the second sensor data. In one aspect, the method further comprises instructing the mobile robot to execute a second mission corresponding to the mission recording, automatically capturing third sensor data when the mobile robot reaches the first waypoint along the route, and automatically storing, on the at least one storage device, the asset identifier as metadata associated with the third sensor data. In one aspect, the method further comprises displaying, on a user interface, an indication of the second sensor data and the third sensor data. In one aspect, the second sensor data and the third sensor data comprises second and third image data, respectively and the method further comprises processing, with a computer vision model each of the second sensor data and the third sensor data to produce a first output and a second output, respectively, and displaying an indication of the second sensor data and the third sensor data comprises displaying the second sensor data with an indication of the first output, and displaying the third sensor data with an indication of the second output.

In one aspect, the method further comprises prompting, on the user interface, the user to provide the second input identifying the first asset within the first sensor data. In one aspect, the method further comprises receiving, via the user interface, a third input from the user identifying a second asset within the first sensor data captured by the mobile robot at the first waypoint, and associating a second asset identifier with the first action in the mission recording, wherein the second asset identifier uniquely identifies the second asset in the environment. In one aspect, the method further comprises receiving, via a user interface, a third input from a user, the third input instructing the mobile robot to perform a second action by recording second sensor data at a second waypoint of the plurality of waypoints, receiving, via the user interface, a fourth input from the user identifying the first asset within the second sensor data captured by a mobile robot at the second waypoint, and associating the first asset identifier with the second action in the mission recording.

In some embodiments, a robot is provided. The robot comprises a navigation system configured to navigate a mobile robot to traverse a route through an environment, a perception system including an image sensor configured to capture an image, and at least one computer processor. The at least one computer processor is configured to generate, during navigation of the mobile robot along the route, a mission recording that includes a plurality of waypoints and edges connecting pairs of the plurality of waypoints, receive, via a user interface, a first input from a user, the first input instructing the mobile robot to perform a first action by recording first sensor data at a first waypoint of the plurality of waypoints, receive, via the user interface, a second input from the user identifying a first asset within the first sensor data captured by a mobile robot at the first waypoint, and associate a first asset identifier with the first action in the mission recording, wherein the first asset identifier uniquely identifies the first asset in the environment.

In one aspect, the at least one computer processor is further configured to instruct the mobile robot to execute a first mission corresponding to the mission recording, automatically capture second sensor data when the mobile robot reaches the first waypoint along the route, and automatically store, on at least one storage device, the asset identifier as metadata associated with the second sensor data. In one aspect, the at least one computer processor is further configured to instruct the mobile robot to execute a second mission corresponding to the mission recording, automatically capture third sensor data when the mobile robot reaches the first waypoint along the route, and automatically store, on the at least one storage device, the asset identifier as metadata associated with the third sensor data. In one aspect, the at least one computer processor is further configured to display, on a user interface, an indication of the second sensor data and the third sensor data. In one aspect, the second sensor data and the third sensor data comprises second and third image data, respectively and the at least one computer processor is further configured to process, with a computer vision model each of the second sensor data and the third sensor data to produce a first output and a second output, respectively, and displaying an indication of the second sensor data and the third sensor data comprises displaying the second sensor data with an indication of the first output, and displaying the third sensor data with an indication of the second output.

In one aspect, the at least one computer processor is further configured to prompt, on the user interface, the user to provide the second input identifying the first asset within the first sensor data. In one aspect, the at least one computer processor is further configured to receive, via the user interface, a third input from the user identifying a second asset within the first sensor data captured by the mobile robot at the first waypoint, and associate a second asset identifier with the first action in the mission recording, wherein the second asset identifier uniquely identifies the second asset in the environment. In one aspect, the at least one computer processor is further configured to receive, via a user interface, a third input from a user, the third input instructing the mobile robot to perform a second action by recording second sensor data at a second waypoint of the plurality of waypoints, receive, via the user interface, a fourth input from the user identifying the first asset within the second sensor data captured by a mobile robot at the second waypoint, and associate the first asset identifier with the second action in the mission recording.

In some embodiments, a non-transitory computer readable medium encoded with a plurality of instructions that, when executed by at least one computer processor perform a method is provided. The method comprises navigating a mobile robot to traverse a route through an environment, generating, during navigation of the mobile robot along the route, a mission recording that includes a plurality of waypoints and edges connecting pairs of the plurality of waypoints, receiving, via a user interface, a first input from a user, the first input instructing the mobile robot to perform a first action by recording first sensor data at a first waypoint of the plurality of waypoints, receiving, via the user interface, a second input from the user identifying a first asset within the first sensor data captured by a mobile robot at the first waypoint, and associating a first asset identifier with the first action in the mission recording, wherein the first asset identifier uniquely identifies the first asset in the environment.

In one aspect, the method further comprises instructing the mobile robot to execute a first mission corresponding to the mission recording, automatically capturing second sensor data when the mobile robot reaches the first waypoint along the route, and automatically storing, on at least one storage device, the asset identifier as metadata associated with the second sensor data. In one aspect, the method further comprises instructing the mobile robot to execute a second mission corresponding to the mission recording, automatically capturing third sensor data when the mobile robot reaches the first waypoint along the route, and automatically storing, on the at least one storage device, the asset identifier as metadata associated with the third sensor data. In one aspect, the method further comprises displaying, on a user interface, an indication of the second sensor data and the third sensor data. In one aspect, the second sensor data and the third sensor data comprises second and third image data, respectively and the method further comprises processing, with a computer vision model each of the second sensor data and the third sensor data to produce a first output and a second output, respectively, and displaying an indication of the second sensor data and the third sensor data comprises displaying the second sensor data with an indication of the first output, and displaying the third sensor data with an indication of the second output.

In one aspect, the method further comprises prompting, on the user interface, the user to provide the second input identifying the first asset within the first sensor data. In one aspect, the method further comprises receiving, via the user interface, a third input from the user identifying a second asset within the first sensor data captured by the mobile robot at the first waypoint, and associating a second asset identifier with the first action in the mission recording, wherein the second asset identifier uniquely identifies the second asset in the environment. In one aspect, the method further comprises receiving, via a user interface, a third input from a user, the third input instructing the mobile robot to perform a second action by recording second sensor data at a second waypoint of the plurality of waypoints, receiving, via the user interface, a fourth input from the user identifying the first asset within the second sensor data captured by a mobile robot at the second waypoint, and associating the first asset identifier with the second action in the mission recording.

In some embodiments, a method of monitoring a physical asset in an environment over time using a mobile robot is provided. The method comprises determining, within a region of interest defined within each of a plurality of images captured by a mobile robot over time, at least one quantity associated with a physical asset represented in the region of interest, wherein the determining is performed using a computer vision model configured based on asset information associated with the physical asset, generating, based on the at least one quantity associated with the asset for the plurality of images, a trend analysis for the at least one quantity, and outputting an indication of the trend analysis.

In one aspect, the at least one quantity includes one or more of a temperature, a pressure, a vibration, and a radiation amount. In one aspect, outputting an indication of the trend analysis comprises providing on a user interface, the indication of the trend analysis. In one aspect, the method further comprises generating an alert based, at least in part, on the trend analysis.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A illustrates an example of a robot configured to navigate in an environment along a route, in accordance with some embodiments;

FIG. 1B is a block diagram of components of a robot, such as the robot shown in FIG. 1A;

FIG. 2 illustrates components of a navigation system used to navigate a robot, such as the robot of FIG. 1A in an environment, in accordance with some embodiments;

FIG. 3A displays a portion of a user interface provided on a robot controller to enable an operator to create an action during a mission recording process, in accordance with some embodiments;

FIG. 3B displays a portion of a user interface provided on a robot controller to enable an operator to specify a region of interest on an isothermal rendering of an environment of a robot, in accordance with some embodiments;

FIG. 3C displays a portion of a user interface provided on a robot controller to enable an operator to specify a region of interest on a color rendering of an environment of a robot, in accordance with some embodiments;

FIG. 4 is a flowchart of a process for automatic monitoring of an asset in an environment using one or more images captured by a mobile robot, in accordance with some embodiments;

FIG. 5 is a flowchart of a process for generating a mission recording that includes asset information, in accordance with some embodiments;

FIG. 6 illustrates an image captured by a robot that has been annotated with alert information, in accordance with some embodiments;

FIGS. 7A and 7B show portions of a user interface configured to display historical data for images captured over time for a single asset in an environment, in accordance with some embodiments;

FIG. 8 shows a portion of a user interface configured to display a plurality of images of an asset captured during different executions of a mission, in accordance with some embodiments;

FIG. 9 shows a historical trend analysis for one or more characteristics of a monitored asset in an environment, in accordance with some embodiments; and

FIG. 10 is a block diagram of components of a robot on which some embodiments may be implemented.

### DETAILED DESCRIPTION

Some robots are used to navigate environments to perform a variety of tasks or functions. These robots are often operated to perform a “mission” by navigating the robot through an environment. The mission is sometimes recorded so that the robot can again perform the mission at a later time. In some missions, a robot both navigates through and interacts with the environment. The interaction sometimes takes the form of gathering data using one or more sensors.

An industrial facility including physical assets that need to be inspected and maintained over several years of operation is an example of a type of environment in which an automated inspection system using such robots may be useful. The infrastructure in industrial facilities often lacks instrumentation that allows for remote monitoring of the health of the physical assets, resulting in predictive maintenance of the assets being a costly manual process. To this end, some embodiments of the present disclosure relate to an automated inspection platform integrated with a mobile robot to enable remote, repetitive, and reliable inspection of physical assets in a facility, thereby reducing the reliance of predictive maintenance of such assets on manual inspection by humans.

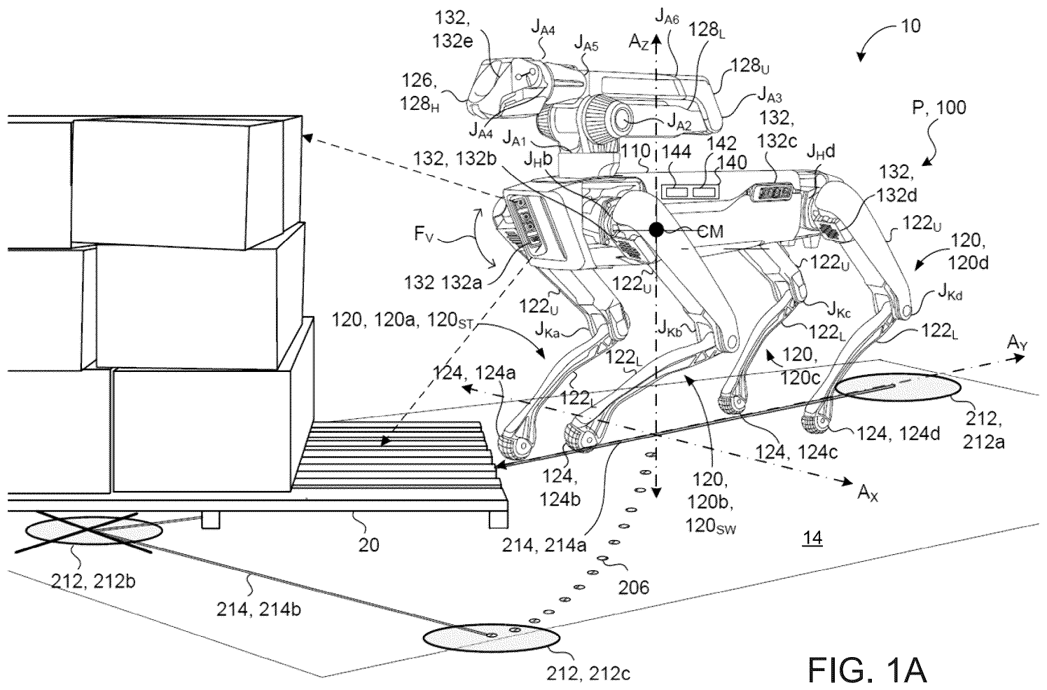

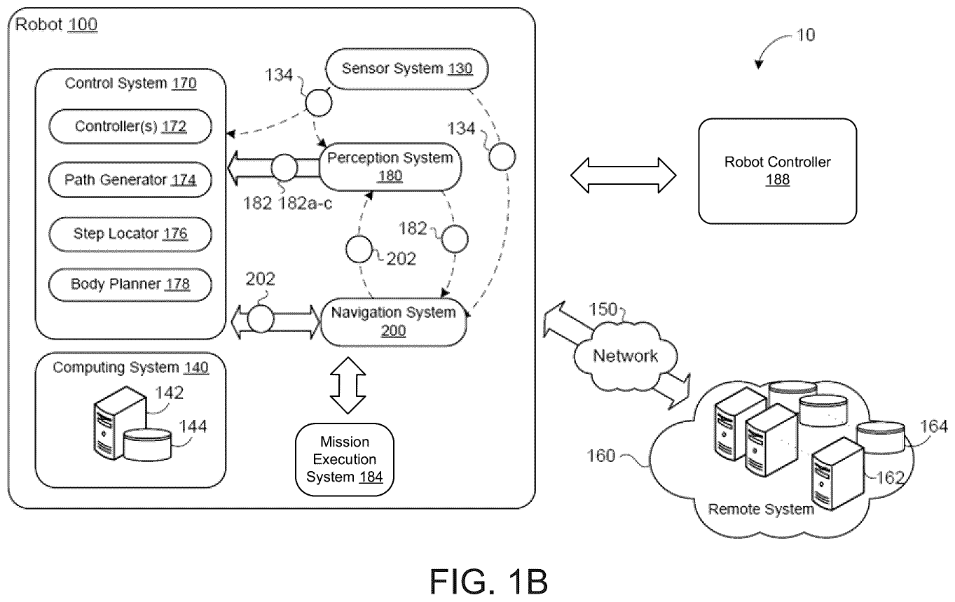

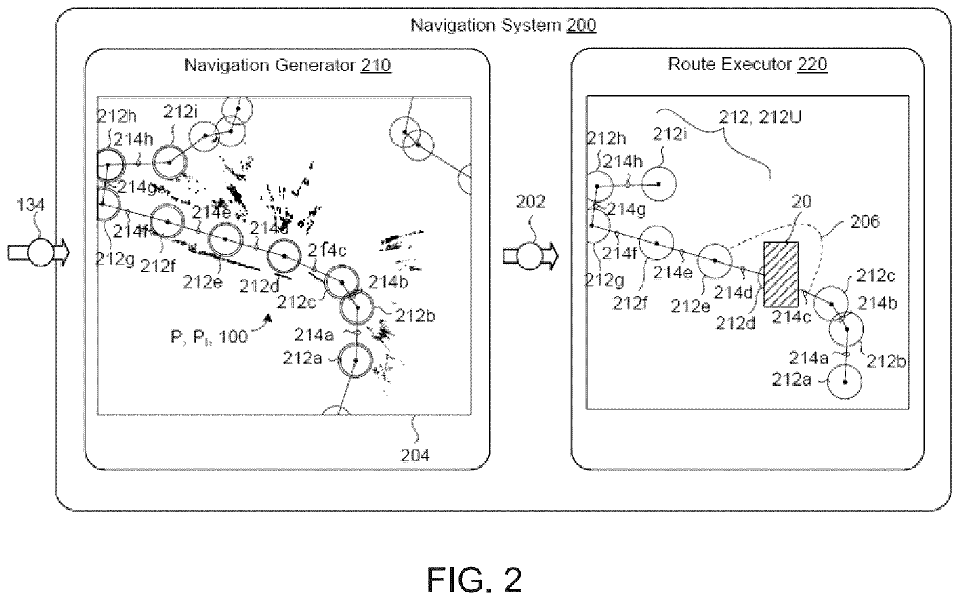

An example of a robot 100 that is capable of performing missions is described below in connection with FIGS. 1A-B. To enable the robot 100 to execute a mission, the robot 100 may undergo an initial mapping process during which the robot 100 moves about an environment 10 (typically in response to commands input by a user to a tablet or other controller) to gather data (e.g., via one or more sensors) about the environment 10 and may generate a topological map 204 (an example of which is shown in FIG. 2) that defines waypoints 212 along a path travelled by the robot 100 and edges 214 representing paths between respective pairs of waypoints 212. Individual waypoints 212 may, for example, be associated with sensor data, fiducials, and/or robot pose information at specific times and places, whereas individual edges 214 may connect waypoints 212 topologically.

In some existing systems, a given “mission recording” may identify a sequence of actions that are to take place at particular waypoints 212 included on a topological map 204. For instance, a mission recording may indicate that the robot 100 is to go to a first waypoint 212 and perform a first action, then go to a second waypoint 212 and perform a second action, etc. In some implementations, such a mission recording need not specify all of the waypoints 212 the robot 100 will actually traverse when the mission is executed, and may instead specify only those waypoints 212 at which particular actions are to be performed.

As explained in detail below, such a mission recording may be executed by a mission execution system 184 (shown in FIG. 1B) of the robot 100. The mission execution system 184 may communicate with other systems of the robot 100, as needed, to execute the mission successfully. For instance, in some implementations, the mission execution system 184 may communicate with a navigation system 200 (also shown in FIG. 1B) requesting that the navigation system 200 determine, using a topological map 204 and the mission recording, a navigation route 202 that includes the various waypoints 212 of the topological map 204 that are identified in the mission recording, as well as any number of additional waypoints 212 of the topological map 204 that are located between the waypoints 212 that are identified in the mission recording. The determined navigation route 202 may likewise include the edges 214 that are located between respective pairs of such waypoints 212. Causing the robot to follow a navigation route 202 that includes all of the waypoints 212 identified in the mission recording may enable the mission execution system 184 to perform the corresponding actions in the mission recording when the robot 100 reaches those waypoints 212.

As described below with reference to FIG. 2, the navigation system 200 may include a navigation generator 210 that can generate a navigation route 202 that includes specified waypoints 212 (e.g., the waypoints identified in a mission recording), as well as a route executor 220 configured to control the robot 100 to move along the identified navigation route 202, possibly re-routing the robot along an alternate path 206, e.g., if needed to avoid an obstacle 20 that may not have been present at the time of recording of the mission.

Examples of actions that can be performed at waypoints 212 of a mission recording include capturing sensor data used to inspect one or more characteristics of physical assets in the environment. For example, the sensor data may include image data (e.g., visual image data and/or thermal image data), which may be processed using one more computer vision models to determine one or more characteristics (e.g., wear, temperature, radiation, sounds, vibration, etc.) of one or more physical assets.

As noted above, in some existing systems, a mission recording may identify particular actions the robot 100 is to take when it reaches specific waypoints 212. For instance, with reference to the right-hand side of FIG. 2, a mission recording may specify that the robot 100 is to capture a first image when it reaches a first waypoint 212d, and is to capture a second image when it reaches a second waypoint 212e. In such a case, when the mission execution system 184 determines that the robot 100 has reached the first waypoint 212d, the mission execution system 184 may instruct a system of the robot to capture the first image. Similarly, when the mission execution system 184 determines that the robot 100 has reached the second waypoint 212e, the mission execution system 184 may instruct that same system (or a different system) of the robot to capture the second image. Repeated executions of the mission over days, months and/or years may be used to implement an inspection system in which a data set including sensor data captured at consistent locations is acquired. The sensor data in the data set may be used, for example, to perform long term trend analysis of characteristics of physical assets in a facility and/or to automatically detect anomalies with respect to physical assets that may require manual intervention.

The inventors have recognized and appreciated that manually processing the amount (e.g., gigabytes) of sensor data that may be acquired using an inspection system, such as the inspection system described herein, can be a time consuming and error prone process. Accordingly, some embodiments of the present disclosure relate to techniques for facilitating an automated analysis of sensor data for physical asset inspection. For instance, as described in more detail below, some implementations provide a user interface that enables a user (e.g., an operator of the robot) to specify a region of interest (ROI) within an image captured by a sensor of a robot, wherein the ROI includes a physical asset of interest to be monitored. A unique asset identifier (asset ID) may be associated with that physical asset to distinguish data for the physical asset from data for another physical asset of interest, which may be associated with a different asset ID. The asset IDs assigned to different monitored physical assets in a facility may be used, among other things, to track characteristics of the same asset across multiple images in the data set and/or to distinguish multiple assets in a single image. Processing images, as one type of sensor data that may be acquired using an automated inspection system as described herein, using asset IDs is described in more detail below.

Referring to FIG. 1A, a robot 100 may include a body 110 with locomotion based structures such as legs 120a-d coupled to the body 110 that enable the robot 100 to move about an environment 10. In some implementations, each leg 120 may be an articulable structure such that one or more joints J permit members 122 of the leg 120 to move. For instance, each leg 120 may include a hip joint J_{H} coupling an upper member 122, 122u of the leg 120 to the body 110, and a knee joint J_{K} coupling the upper member 122u of the leg 120 to a lower member 122_{L} of the leg 120. For impact detection, the hip joint J_{H} may be further broken down into abduction-adduction rotation of the hip joint J_{H} for occurring in a frontal plane of the robot 100 (i.e., an X-Z plane extending in directions of the x-direction axis Aₓ and the z-direction axis A_{Z}) and a flexion-extension rotation of the hip joint J_{H} for occurring in a sagittal plane of the robot 100 (i.e., a Y-Z plane extending in directions of the y-direction axis A_{Y} and the z-direction axis A_{Z}). Although FIG. 1A depicts a quadruped robot with four legs 120a-d, it should be appreciated that the robot 100 may include any number of legs or locomotive based structures (e.g., a biped or humanoid robot with two legs) that provide a means to traverse the terrain within the environment 10.

In order to traverse the terrain, each leg 120 may have a distal end 124 that contacts a surface 14 of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 may correspond to a “foot” of the robot 100. In some examples, although not shown, the distal end 124 of the leg 120 may include an ankle joint such that the distal end 124 is articulable with respect to the lower member 122_{L} of the leg 120.

In the illustrated example, the robot 100 includes an arm 126 that functions as a robotic manipulator. The arm 126 may be configured to move about multiple degrees of freedom in order to engage elements of the environment 10 (e.g., objects within the environment 10). In some implementations, the arm 126 may include one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128u, and a hand member 128x (e.g., also referred to as an end-effector 128x). Here, the lower member 128_{L} may rotate or pivot about one or more arm joints J_{A} located adjacent to the body 110 (e.g., where the arm 126 connects to the body 110 of the robot 100). For example, FIG. 1A depicts the arm 126 able to rotate about a first arm joint J_{A1} or yaw arm joint. With a yaw arm joint, the arm 126 is able to rotate in “360” degrees (or some portion thereof) axially about a vertical gravitational axis (e.g., shown as A_{z}) of the robot 100. The lower member 128f, may pivot (e.g., while rotating) about a second arm joint J_{A2}. For instance, the second arm joint JAZ (shown adjacent the body 110 of the robot 100) allows the arm 126 to pitch to a particular angle (e.g., raising or lowering one or more members 128 of the arm 126). The lower member 128_{L} may be coupled to the upper member 128_{U} at a third arm joint J_{A3} and the upper member 128_{U} may be coupled to the hand member 128_{H} at a fourth arm joint J_{A4}. In some examples, such as FIG. 1A, the hand member 128_{H} or end-effector 128_{H} may be a mechanical gripper that includes a one or more moveable jaws configured to perform different types of grasping of elements within the environment 10. In the example shown, the end-effector 128_{H} includes a fixed first jaw and a moveable second jaw that grasps objects by clamping the object between the jaws. The moveable jaw may be configured to move relative to the fixed jaw in order to move between an open position for the gripper and a closed position for the gripper (e.g., closed around an object).

In some implementations, the arm 126 may include additional joints J_{A} such as the fifth arm joint J_{A5} and/or the sixth arm joint J_{A6}. The fifth joint J_{A5} may be located near the coupling of the upper member 128_{U} to the hand member 128_{H} and may function to allow the hand member 128_{H} to twist or to rotate relative to the lower member 128u. In other words, the fifth arm joint J_{A4} may function as a twist joint similarly to the fourth arm joint J_{A4} or wrist joint of the arm 126 adjacent the hand member 128_{H}. For instance, as a twist joint, one member coupled at the joint J may move or rotate relative to another member coupled at the joint J (e.g., a first member portion coupled at the twist joint is fixed while the second member portion coupled at the twist joint rotates). Here, the fifth joint J_{A5} may also enable the arm 126 to turn in a manner that rotates the hand member 128_{H} such that the hand member 128_{H} may yaw instead of pitch. For instance, the fifth joint J_{A5} may allow the arm 126 to twist within a “180” degree range of motion such that the jaws associated with the hand member 128_{H} may pitch, yaw, or some combination of both. This may be advantageous for hooking some portion of the arm 126 around objects or refining the how the hand member 128_{H} grasps an object. The sixth arm joint J_{A6} may function similarly to the fifth arm joint J_{A5} (e.g., as a twist joint). For example, the sixth arm joint J_{A6} may also allow a portion of an arm member 128 (e.g., the upper arm member 128_{U}) to rotate or twist within a “180” degree range of motion (e.g., with respect to another portion of the arm member 128 or another arm member 128). Here, a combination of the range of motion from the fifth arm joint J_{A5} and the sixth arm joint J_{A6} may enable “360” degree rotation. In some implementations, the arm 126 may connect to the robot 100 at a socket on the body 110 of the robot 100. In some configurations, the socket may be configured as a connector such that the arm 126 may attach or detach from the robot 100 depending on whether the arm 126 is needed for operation. In some examples, the first and second arm joints J_{A1,2} may be located at, adjacent to, or a portion of the socket that connects the arm 126 to the body 110.

The robot 100 may have a vertical gravitational axis (e.g., shown as a Z-direction axis A_{Z}) along a direction of gravity, and a center of mass CM, which is a point where the weighted relative position of the distributed mass of the robot 100 sums to zero. The robot 100 may further have a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 may alter the pose P of the robot 100 (i.e., the combination of the position of the CM of the robot and the attitude or orientation of the robot 100). Here, a height (i.e., vertical distance) generally refers to a distance along (e.g., parallel to) the z-direction (i.e., z-axis A_{Z}). The sagittal plane of the robot 100 corresponds to the Y-Z plane extending in directions of the y-direction axis A_{Y} and the z-direction axis A_{Z}. In other words, the sagittal plane bisects the robot 100 into a left and right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a support surface 14 where distal ends 124 of the legs 120 of the robot 100 may generate traction to help the robot 100 move about the environment 10. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis Ax and the z-direction axis A_{z}.

When a legged robot moves about the environment 10, the legs 120 of the robot may undergo a gait cycle. Generally, a gait cycle begins when a leg 120 touches down or contacts a support surface 14 and ends when that same leg 120 once again contacts the ground surface 14. The touching down of a leg 120 may also be referred to as a “footfall” defining a point or position where the distal end 124 of a locomotion-based structure 120 falls into contact with the support surface 14. The gait cycle may predominantly be divided into two phases, a swing phase and a stance phase. During the swing phase, a leg 120 may undergo (i) lift-off from the support surface 14 (also sometimes referred to as toe-off and the transition between the stance phase and swing phase), (ii) flexion at a knee joint J_{K} of the leg 120, (iii) extension of the knee joint J_{K} of the leg 120, and (iv) touchdown (or footfall) back to the support surface 14. Here, a leg 120 in the swing phase is referred to as a swing leg 120_{SW}. As the swing leg 120_{SW} proceeds through the movement of the swing phase 120_{SW}, another leg 120 performs the stance phase. The stance phase refers to a period of time where a distal end 124 (e.g., a foot) of the leg 120 is on the support surface 14. During the stance phase, a leg 120 may undergo (i) initial support surface contact which triggers a transition from the swing phase to the stance phase, (ii) loading response where the leg 120 dampens support surface contact, (iii) mid-stance support for when the contralateral leg (i.e., the swing leg 120_{SW}) lifts-off and swings to a balanced position (about halfway through the swing phase), and (iv) terminal-stance support from when the robot's CM is over the leg 120 until the contralateral leg 120 touches down to the support surface 14. Here, a leg 120 in the stance phase is referred to as a stance leg 120_{ST}.

In order to maneuver about the environment 10 or to perform tasks using the arm 126, the robot 100 may include a sensor system 130 with one or more sensors 132, 132a-n. For instance, FIG. 1A illustrates a first sensor 132, 132a mounted at a head of the robot 100, a second sensor 132, 132b mounted near the hip of the second leg 120b of the robot 100, a third sensor 132, 132c corresponding one of the sensors 132 mounted on a side of the body 110 of the robot 100, a fourth sensor 132, 132d mounted near the hip of the fourth leg 120d of the robot 100, and a fifth sensor 132, 132e mounted at or near the end-effector 128_{H} of the arm 126 of the robot 100. The sensors 132 may include vision/image sensors, inertial sensors (e.g., an inertial measurement unit (IMU)), force sensors, and/or kinematic sensors. Some examples of sensors 132 include a camera such as a stereo camera, a time-of-flight (TOF) sensor, a scanning light-detection and ranging (LIDAR) sensor, or a scanning laser-detection and ranging (LADAR) sensor. In some implementations, the respective sensors 132 may have corresponding fields of view F_{V}, defining a sensing range or region corresponding to the sensor 132. For instance, FIG. 1A depicts a field of a view Fᵥ for the robot 100. Each sensor 132 may be pivotable and/or rotatable such that the sensor 132 may, for example, change the field of view F_{V} about one or more axis (e.g., an x-axis, a y-axis, or a z-axis in relation to a ground plane).

In some implementations, the sensor system 130 may include sensor(s) 132 coupled to a joint J. In some implementations, these sensors 132 may be coupled to a motor that operates a joint J of the robot 100 (e.g., sensors 132, 132a-b). Here, these sensors 132 may generate joint dynamics in the form of joint-based sensor data 134 (shown in FIG. 1B). Joint dynamics collected as joint-based sensor data 134 may include joint angles (e.g., an upper member 122u relative to a lower member 122_{L}), joint speed (e.g., joint angular velocity or joint angular acceleration), and/or joint torques experienced at a joint J (also referred to as joint forces). Here, joint-based sensor data 134 generated by one or more sensors 132 may be raw sensor data, data that is further processed to form different types of joint dynamics, or some combination of both. For instance, a sensor 132 may measure joint position (or a position of member(s) 122 coupled at a joint J) and systems of the robot 100 may perform further processing to derive velocity and/or acceleration from the positional data. In other examples, one or more sensors 132 may be configured to measure velocity and/or acceleration directly.

When surveying a field of view F_{V} with a sensor 132, the sensor system 130 may likewise generate sensor data 134 (also referred to as image data) corresponding to the field of view F_{V}. The sensor system 130 may generate the field of view F_{V} with a sensor 132 mounted on or near the body 110 of the robot 100 (e.g., sensor(s) 132a, 132b). The sensor system may additionally and/or alternatively generate the field of view F_{V} with a sensor 132 mounted at or near the end-effector 128_{H} of the arm 126 (e.g., sensor(s) 132c).

The one or more sensors 132 may capture sensor data 134 that defines the three-dimensional point cloud for the area within the environment 10 about the robot 100. In some examples, the sensor data 134 may be image data that corresponds to a three-dimensional volumetric point cloud generated by a three-dimensional volumetric image sensor 132.

Additionally or alternatively, when the robot 100 is maneuvering about the environment 10, the sensor system 130 may gather pose data for the robot 100 that includes inertial measurement data (e.g., measured by an IMU). In some examples, the pose data may include kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 10 about the robot 100.

As the sensor system 130 gathers sensor data 134, a computing system 140 may store, process, and/or communicate the sensor data 134 to various systems of the robot 100 (e.g., the computing system 140, the control system 170, the perception system 180, and/or the navigation system 200). In order to perform computing tasks related to the sensor data 134, the computing system 140 of the robot 100 may include data processing hardware 142 and memory hardware 144. The data processing hardware 142 may be configured to execute instructions stored in the memory hardware 144 to perform computing tasks related to activities (e.g., movement and/or movement-based activities) for the robot 100. Generally speaking, the computing system 140 refers to one or more instances of data processing hardware 142 and/or memory hardware 144.

With continued reference to FIGS. 1A and 1B, in some implementations, the computing system 140 may be a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., where a majority of centralized hardware and a minority of decentralized hardware). A decentralized computing system 140 may, for example, allow processing to occur at an activity location (e.g., at motor that moves a joint of a leg 120) while a centralized computing system 140 may, for example, allow for a central processing hub that communicates to systems located at various positions on the robot 100 (e.g., communicate to the motor that moves the joint of the leg 120).

Additionally or alternatively, the computing system 140 may include computing resources that are located remotely from the robot 100. For instance, the computing system 140 may communicate via a network 150 with a remote system 160 (e.g., a remote computer/server or a cloud-based environment). Much like the computing system 140, the remote system 160 may include remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In some implementations, the computing system 140 may be configured to utilize the remote resources 162, 164 as extensions of the computing resources 142, 144 such that resources of the computing system 140 may reside on resources of the remote system 160.

In some implementations, as shown in FIGS. 1A and 1B, the robot 100 may include a control system 170 and a perception system 180. The perception system 180 may be configured to receive the sensor data 134 from the sensor system 130 and process the sensor data 134 to generate one or more perception maps 182. The perception system 180 may communicate such perception map(s) 182 to the control system 170 in order to perform controlled actions for the robot 100, such as moving the robot 100 about the environment 10. In some implementations, by having the perception system 180 separate from, yet in communication with the control system 170, processing for the control system 170 may focus on controlling the robot 100 while the processing for the perception system 180 may focus on interpreting the sensor data 134 gathered by the sensor system 130. For instance, these systems 170, 180 may execute their processing in parallel to ensure accurate, fluid movement of the robot 100 in an environment 10.

In some implementations, the control system 170 may include one or more controllers 172, a path generator 174, a step locator 176, and a body planner 178. The control system 170 may be configured to communicate with at least one sensor system 130 and any other system of the robot 100 (e.g., the perception system 180 and/or the navigation system 200). The control system 170 may perform operations and other functions using hardware 140. The controller(s) 172 may be configured to control movement of the robot 100 to traverse about the environment 10 based on input or feedback from the systems of the robot 100 (e.g., the control system 170, the perception system 180, and/or the navigation system 200). This may include movement between poses and/or behaviors of the robot 100. For example, the controller(s) 172 may control different footstep patterns, leg patterns, body movement patterns, or vision system sensing patterns.

In some implementations, the controller(s) 172 may include a plurality of controllers 172 where each of the controllers 172 may be configured to operate the robot 100 at a fixed cadence. A fixed cadence refers to a fixed timing for a step or swing phase of a leg 120. For example, an individual controller 172 may instruct the robot 100 to move the legs 120 (e.g., take a step) at a particular frequency (e.g., step every 250 milliseconds, 350 milliseconds, etc.). With a plurality of controllers 172, where each controller 172 is configured to operate the robot 100 at a fixed cadence, the robot 100 can experience variable timing by switching between the different controllers 172. In some implementations, the robot 100 may continuously switch/select fixed cadence controllers 172 (e.g., re-selects a controller 170 every three milliseconds) as the robot 100 traverses the environment 10.

In some implementations, the control system 170 may additionally or alternatively include one or more specialty controllers 172 that are dedicated to a particular control purpose. For example, the control system 170 may include one or more stair controllers dedicated to planning and coordinating the robot's movement to traverse a set of stairs. For instance, a stair controller may ensure the footpath for a swing leg 120_{SW} maintains a swing height to clear a riser and/or edge of a stair. Other specialty controllers 172 may include the path generator 174, the step locator 176, and/or the body planner 178.

Referring to FIG. 1B, the path generator 174 may be configured to determine horizontal motion for the robot 100. As used herein, the term “horizontal motion” refers to translation (i.e., movement in the X-Y plane) and/or yaw (i.e., rotation about the Z-direction axis A_{z}) of the robot 100. The path generator 174 may determine obstacles within the environment 10 about the robot 100 based on the sensor data 134. The path generator 174 may determine the trajectory of the body 110 of the robot for some future period (e.g., for the next one second). Such determination of the trajectory of the body 110 by the path generator 174 may occur much more frequently, however, such as hundreds of times per second. In this manner, in some implementations, the path generator 174 may determine a new trajectory for the body 110 every few milliseconds, with each new trajectory being planned for a period of one or so seconds into the future.

The path generator 174 may communicate information concerning currently planned trajectory, as well as identified obstacles, to the step locator 176 such that the step locator 176 may identify foot placements for legs 120 of the robot 100 (e.g., locations to place the distal ends 124 of the legs 120 of the robot 100). The step locator 176 may generate the foot placements (i.e., locations where the robot 100 should step) using inputs from the perception system 180 (e.g., perception map(s) 182). The body planner 178, much like the step locator 176, may receive inputs from the perception system 180 (e.g., perception map(s) 182). Generally speaking, the body planner 178 may be configured to adjust dynamics of the body 110 of the robot 100 (e.g., rotation, such as pitch or yaw and/or height of CM) to successfully move about the environment 10.

The perception system 180 may enable the robot 100 to move more precisely in a terrain with various obstacles. As the sensors 132 collect sensor data 134 for the space about the robot 100 (i.e., the robot's environment 10), the perception system 180 may use the sensor data 134 to form one or more perception maps 182 for the environment 10. In some implementations, the perception system 180 may also be configured to modify an existing perception map 182 (e.g., by projecting sensor data 134 on a preexisting perception map) and/or to remove information from a perception map 182.

In some implementations, the one or more perception maps 182 generated by the perception system 180 may include a ground height map 182, 182a, a no step map 182, 182b, and a body obstacle map 182, 182c. The ground height map 182a refers to a perception map 182 generated by the perception system 180 based on voxels from a voxel map. In some implementations, the ground height map 182a may function such that, at each X-Y location within a grid of the perception map 182 (e.g., designated as a cell of the ground height map 182a), the ground height map 182a specifies a height. In other words, the ground height map 182a may convey that, at a particular X-Y location in a horizontal plane, the robot 100 should step at a certain height.

The no step map 182b generally refers to a perception map 182 that defines regions where the robot 100 is not allowed to step in order to advise the robot 100 when the robot 100 may step at a particular horizontal location (i.e., location in the X-Y plane). In some implementations, much like the body obstacle map 182c and the ground height map 182a, the no step map 182b may be partitioned into a grid of cells in which each cell represents a particular area in the environment 10 of the robot 100. For instance, each cell may correspond to a three centimeter square within an X-Y plane within the environment 10. When the perception system 180 generates the no-step map 182b, the perception system 180 may generate a Boolean value map where the Boolean value map identifies no step regions and step regions. A no step region refers to a region of one or more cells where an obstacle exists while a step region refers to a region of one or more cells where an obstacle is not perceived to exist. The perception system 180 may further process the Boolean value map such that the no step map 182b includes a signed-distance field. Here, the signed-distance field for the no step map 182b may include a distance to a boundary of an obstacle (e.g., a distance to a boundary of the no step region 244) and a vector “v” (e.g., defining nearest direction to the boundary of the no step region 244) to the boundary of an obstacle.

The body obstacle map 182c may be used to determine whether the body 110 of the robot 100 overlaps a location in the X-Y plane with respect to the robot 100. In other words, the body obstacle map 182c may identify obstacles for the robot 100 to indicate whether the robot 100, by overlapping at a location in the environment 10, risks collision or potential damage with obstacles near or at the same location. As a map of obstacles for the body 110 of the robot 100, systems of the robot 100 (e.g., the control system 170) may use the body obstacle map 182c to identify boundaries adjacent, or nearest to, the robot 100 as well as to identify directions (e.g., an optimal direction) to move the robot 100 in order to avoid an obstacle. In some implementations, much like other perception maps 182, the perception system 180 may generate the body obstacle map 182c according to a grid of cells (e.g., a grid of the X-Y plane). Here, each cell within the body obstacle map 182c may include a distance from an obstacle and a vector pointing to the closest cell that is an obstacle (i.e., a boundary of the obstacle).

Referring further to FIG. 1B, the robot 100 may also include a navigation system 200 and a mission execution system 184. The navigation system 200 may be a system of the robot 100 that navigates the robot 100 along a path referred to as a navigation route 202 in order to traverse an environment 100. The navigation system 200 may be configured to receive the navigation route 202 as input or to generate the navigation route 202 (e.g., in its entirety or some portion thereof). To generate the navigation route 202 and/or to guide the robot 100 along the navigation route 202, the navigation system 200 may be configured to operate in conjunction with the control system 170 and/or the perception system 180. For instance, the navigation system 200 may receive perception maps 182 that may inform decisions performed by the navigation system 200 or otherwise influence some form of mapping performed by the navigation system 200 itself. The navigation system 200 may operate in conjunction with the control system 170 such that one or more controllers 172 and/or specialty controller(s) 174, 176, 178 may control the movement of components of the robot 100 (e.g., legs 120 and/or the arm 126) to navigate along the navigation route 202.

The mission execution system 184, which is described in further detail below, may be a system of the robot 100 that is responsible for executing recorded missions. A recorded mission may, for example, specify a sequence of one or more actions that the robot 100 is to perform at respective waypoints 212 defined on a topological map 204 (shown in FIG. 2).

As additionally shown in FIG. 1B, in some implementations, a robot controller 188 may be in wireless (or wired) communication with the robot 100 (via the network 150 or otherwise) and may allow an operator to control the robot 100. In some implementations, the robot controller 188 may be a tablet computer with “soft” UI controls for the robot 100 being presented via a touchscreen of the tablet. In other implementations, the robot controller 188 may take the form of a traditional video game controller, but possibly including a display screen, and may include a variety of physical buttons and/or soft buttons that can be depressed or otherwise manipulated to control the robot 100.

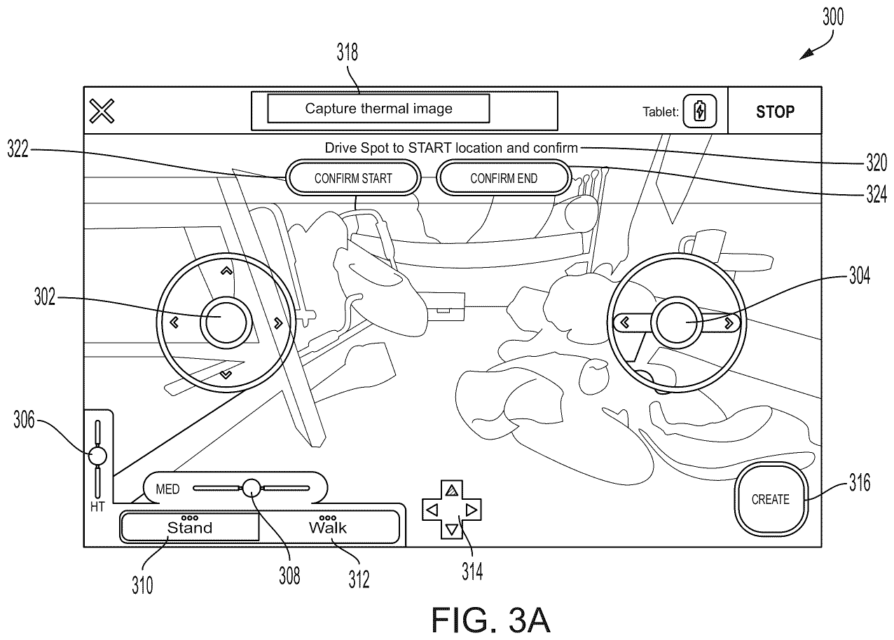

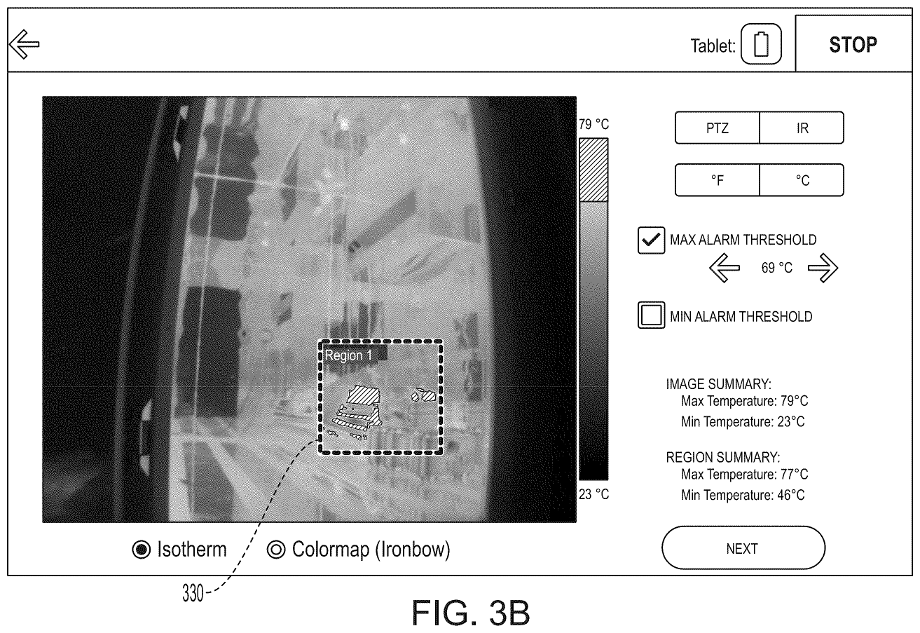

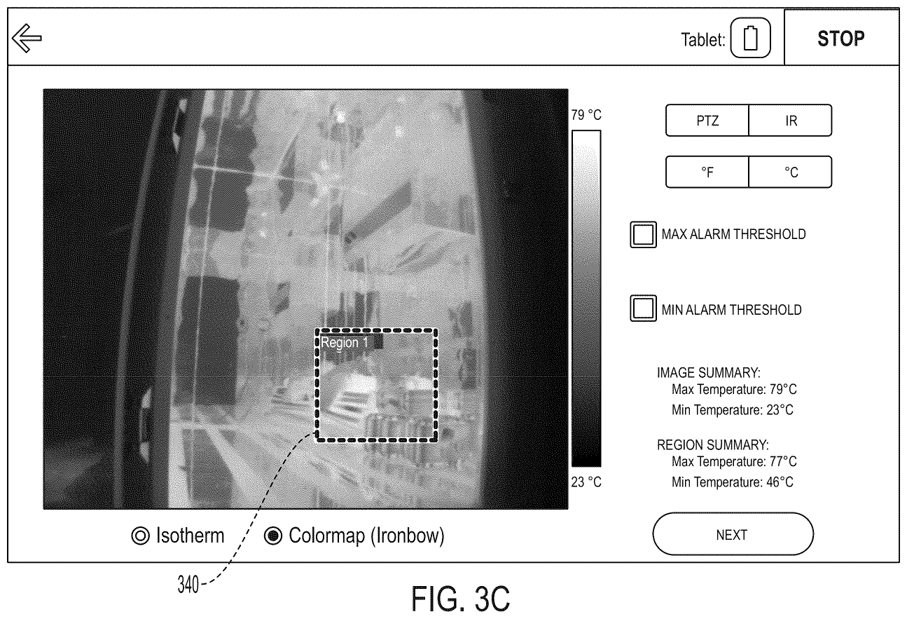

In some implementations, an operator may use the robot controller 188 to initiate a mission recording process. During such a process, the operator may direct movement of the robot 100 (e.g., via the robot controller 188) and instruct the robot 100 to take various “mission actions” (e.g., taking sensor readings, surveillance video, etc.) along the desired path of the mission. An example of a user interface presented on a robot controller 188 for controlling operation of the robot 100 is shown in FIG. 3A, described in more detail below. As a mission is being recorded, the robot 100 may generate a topological map 204 (shown in FIG. 2) including waypoints 212 at various locations along its path, as well as edges 214 between such waypoints 212. In some implementations, for each mission action the operator instructs the robot to perform, a new waypoint 212 may be added to the topological map 204 that is being generated on the robot 100. Further, for each such mission action, data may be stored in the topological map 204 and/or the mission recording to associate the mission action identified in the mission recording with the waypoint 212 of the topological map 204 at which that mission action was performed. In some implementations, at the end of the mission recording process, the topological map 204 generated during mission recording may be transferred to the robot controller 188 and/or another computing device in communication with (e.g., coupled wirelessly to) the robot, and may be stored in association with the mission recording.

Subsequent to the mission recording process, the mission recording and, if not already present on the robot 100, the associated topological map 204, may be provided to the robot 100, and the robot 100 may be instructed to execute the recorded mission (e.g., autonomously).

A detailed description of the route executor 220 of the navigation system 200 will now be provided with reference to FIG. 2. As described above, a navigation route 202 that is executed by the route executor 220 may include a sequence of instructions that cause the robot 100 to move along a path corresponding to a sequence of waypoints 212 defined on a topological map 204 (shown in FIG. 2). As the route executor 220 guides the robot 100 through movements that follow the navigation route 202, the route executor 220 may determine whether the navigation route 202 becomes obstructed by an object. As noted above, in some implementations, the navigation route 202 may include one or more features of a topological map 204. For example, as previously described, such a topological map 204 may include waypoints 212 and edges 214 and the navigation route 202 may indicate that the robot 100 is to travel along a path that includes a particular sequence of those waypoints 212. In some implementations, the navigation route 202 may further include movement instructions that specify how the robot 100 is to move from one waypoint 212 to another. Such movement instructions may, for example, account for objects or other obstacles at the time of recording the waypoints 212 and edges 214 to the topological map 204.

Since the environment 10 may dynamically change from the time of recording the waypoints 212 to the topological map 204, the route executor 220 may be configured to determine whether the navigation route 202 becomes obstructed by an object that was not previously identified when recording the waypoints 212 on the topological map 204 being used by the navigation route 202. Such an object may be considered an “unforeseeable obstacle” in the navigation route 202 because the initial mapping process that informs the navigation route 202 did not recognize the object in the location of the obstructed object. This may occur, for example, when an object is moved or introduced to a mapped environment.

As shown in FIG. 2, when an unforeseeable obstacle obstructs the navigation route 202, the route executor 220 may attempt to generate an alternative path 206 to another feature on the topological map 204 that avoids the unforeseeable obstacle. This alternative path 206 may deviate from the navigation route 202 temporarily, but then resume the navigation route 202 after the deviation. Unlike other approaches to generate an obstacle avoidance path, the route executor 220 seeks to only temporarily deviate from the navigation route 202 to avoid the unforeseeable obstacle such that the robot 100 may return to using course features (e.g., like topological features from the topological map 204) for the navigation route 202. In this sense, successful obstacle avoidance for the route executor 220 occurs when an obstacle avoidance path both (i) avoids the unforeseeable obstacle and (ii) enables the robot 100 to resume some portion of the navigation route 202. This technique to merge back with the navigation route 202 after obstacle avoidance may be advantageous because the navigation route 202 may be important for task or mission performance for the robot 100 (or an operator of the robot 100). For instance, an operator of the robot 100 may have tasked the robot 100 to perform an inspection task at a waypoint 212 of the navigation route 202. By generating an obstacle avoidance route that continues on the navigation route 202 after obstacle avoidance, the navigation system 200 aims to promote task or mission success for the robot 100.

To illustrate, FIG. 1A depicts the robot 100 traveling along a navigation route 202 that includes three waypoints 212a—c. While moving along a first portion of the navigation route 202 (e.g., shown as a first edge 214a) from a first waypoint 212a to a second waypoint 212b, the robot 100 encounters an unforeseeable obstacle 20 depicted as a partial pallet of boxes. This unforeseeable obstacle 20 blocks the robot 100 from completing the first portion of the navigation route 202 to the second waypoint 212b. Here, the “X” over the second waypoint 212b symbolizes that the robot 100 is unable to travel successfully to the second waypoint 212b given the pallet of boxes. As depicted, the navigation route 202 would normally have a second portion (e.g., shown as a second edge 214b) that extends from the second waypoint 212b to a third waypoint 212c. Due to the unforeseeable object 20, however, the route executor 220 generates an alternative path 206 that directs the robot 100 to move to avoid the unforeseeable obstacle 20 and to travel to the third waypoint 212c of the navigation route 202 (e.g., from a point along the first portion of the navigation route 202). In this respect, the robot 100 may not be able to navigate successfully to one or more waypoints 212, such as the second waypoint 212b, but may resume a portion of the navigation route 202 after avoiding the obstacle 20. For instance, the navigation route 202 may include additional waypoints 212 subsequent to the third waypoint 212c and the alternative path 206 may enable the robot 100 to continue to those additional waypoints 212 after the navigation system 200 directs the robot 100 to the third waypoint 212c via the alternative path 206.

As shown in FIG. 2, and as briefly noted above, the navigation system 200 may include a navigation generator 210 that operates in conjunction with the route generator 220. The navigation generator 210 (also referred to as the generator 210) may be configured to construct a topological map 204 (e.g., during a mission recording process) as well as to generate the navigation route 202 based on the topological map 204. To generate the topological map 204, the navigation system 200 and, more particularly, the generator 210, may record sensor data corresponding to locations within an environment 10 that has been traversed or is being traversed by the robot 100 as waypoints 212. As noted above, a waypoint 212 may include a representation of what the robot 100 sensed (e.g., according to its sensor system 120) at a particular place within the environment 10. The generator 210 may generate waypoints 212, for example, based on the image data 134 collected by the sensor system 130 of the robot 100. For instance, a robot 100 may perform an initial mapping process where the robot 100 moves through the environment 10. While moving through the environment 10, systems of the robot 100, such as the sensor system 130 may gather data (e.g., sensor data 134) as a means to understand the environment 10. By obtaining an understanding of the environment 10 in this fashion, the robot 100 may later move about the environment 10 (e.g., autonomously, semi-autonomously, or with assisted operation by a user) using the information or a derivative thereof gathered from the initial mapping process.

In some implementations, the navigation generator 210 may build the topological map 204 by executing at least one waypoint heuristic (e.g., waypoint search algorithm) that triggers the navigation generator 210 to record a waypoint placement at a particular location in the topological map 204. For example, such a waypoint heuristic may be configured to detect a threshold feature detection within the image data 134 at a location of the robot 100 (e.g., when generating or updating the topological map 204). The navigation generator 210 (e.g., using a waypoint heuristic) may identify features within the environment 10 that function as reliable vision sensor features offering repeatability for the robot 100 to maneuver about the environment 10. For instance, a waypoint heuristic of the generator 210 may be pre-programmed for feature recognition (e.g., programmed with stored features) or programmed to identify features where spatial clusters of volumetric image data 134 occur (e.g., corners of rooms or edges of walls). In response to the at least one waypoint heuristic triggering the waypoint placement, the navigation generator 210 may record the waypoint 212 on the topological map 204. This waypoint identification process may be repeated by the navigation generator 210 as the robot 100 drives through an area (e.g., the robotic environment 10). For instance, an operator of the robot 100 may manually drive the robot 100 through an area for an initial mapping process that establishes the waypoints 212 for the topological map 204.

When recording each waypoint 212, the generator 210 may associate waypoint edges 214 (also referred to as edges 214) with sequential pairs of respective waypoints 212 such that the topological map 204 produced by the generator 210 includes both waypoints 212 and edges 214 between pairs of those waypoints 212. An edge 214 may indicate how one waypoint 212 (e.g., a first waypoint 212a) is related to another waypoint 212 (e.g., a second waypoint 212b). For example, an edge 214 may represent a positional relationship between a pair of adjacent waypoints 212. In other words, an edge 214 may represent a connection or designated path between two waypoints 212 (e.g., the edge 214a shown in FIG. 2 may represent a connection between the first waypoint 212a and the second waypoint 212b).

In some implementations, each edge 214 may thus represent a path (e.g., a movement path for the robot 100) between the pair of waypoints 212 it interconnects. Further, in some implementations, individual edges 214 may also reflect additional useful information. In particular, the route executor 220 of the navigation system 200 may be configured to recognize particular annotations on the edges 214 and control other systems of the robot 100 to take actions that are indicated by such annotations. For example, one or more edges 214 may be annotated to include movement instructions that inform the robot 100 how to move or navigate between waypoints 212 they interconnect. Such movement instructions may, for example, identify a pose transformation for the robot 100 before it moves along the edge 214 between two waypoints 212. A pose transformation may thus describe one or more positions and/or orientations for the robot 100 to assume to successfully navigate along the edge 214 between two waypoints 212. In some implementations, an edge 214 may be annotated to specify a full three-dimensional pose transformation (e.g., six numbers). Some of these numbers represent estimates, such as a dead reckoning pose estimation, a vision based estimation, or other estimations based on kinematics and/or inertial measurements of the robot 100.

In some implementations, one or more edges 214 may additionally or alternatively include annotations that provide further an indication/description of the environment 10. Some examples of annotations include a description or an indication that an edge 214 is associated with or located on some feature of the environment 10. For instance, an annotation for an edge 214 may specify that the edge 214 is located on stairs or passes through a doorway. Such annotations may aid the robot 100 during maneuvering, especially when visual information is missing or lacking (e.g., due to the presence of a doorway). In some configurations, edge annotations may additionally or alternatively identify one or more directional constraints (which may also be referred to as “pose constraints”). Such directional constraints may, for example, specify an alignment and/or an orientation (e.g., a pose) for the robot 100 to enable it to navigate over or through a particular environment feature. For example, such an annotation may specify a particular alignment or pose the robot 100 is to assume before traveling up or down stairs or down a narrow corridor that may restrict the robot 100 from turning.

In some implementations, sensor data 134 may be associated with individual waypoints 212 of the topological map 204. Such sensor data 134 may have been collected by the sensor system 130 of the robot 100 when the generator 210 recorded respective waypoints 212 to the topological map 204. The sensor data 134 stored for the individual waypoints 212 may enable the robot 100 to localize by comparing real-time sensor data 134 gathered as the robot 100 traverses the environment 10 according to the topological map 204 (e.g., via a route 202) with sensor data 134 stored for the waypoints 212 of the topological map 204. In some configurations, after the robot 100 moves along an edge 214 (e.g., with the goal of arriving at a target waypoint 212), the robot 100 may localize by directly comparing real-time sensor data 134 with the sensor data 134 associated with the intended target waypoint 212 of the topological map 204. In some implementations, by storing raw or near-raw sensor data 134 (i.e., with minimal processing) for the waypoints 212 of the topological map 204, the robot 100 may use real-time sensor data 134 to localize efficiently as the robot 100 maneuvers within the mapped environment 10. In some examples, an iterative closest points (ICP) algorithm may be used to localize the robot 100 with respect to a given waypoint 212.

By producing the topological map 204 using waypoints 212 and edges 214, the topological map 204 may be locally consistent (e.g., spatially consistent within an area due to neighboring waypoints), but need not be globally accurate and/or consistent. That is, as long as geometric relations (e.g., edges 214) between adjacent waypoints 212 are roughly accurate, the topological map 204 does not require precise global metric localization for the robot 100 and any sensed objects within the environment 10. As such, a navigation route 202 derived or built using the topological map 202 also does not need precise global metric information. Moreover, because the topological map 204 may be built based on waypoints 212 and relationships between waypoints (e.g., edges 214), the topological map 204 may be considered an abstraction or high-level map, as opposed to a metric map. That is, in some implementations, the topological map 204 may be devoid of other metric data about the mapped environment 10 that does not relate to waypoints 212 or their corresponding edges 214. For instance, in some implementations, the mapping process (e.g., performed by the generator 210) that creates the topological map 204 may not store or record other metric data, and/or the mapping process may remove recorded metric data to form a topological map 204 of waypoints 212 and edges 214. Either way, navigating with the topological map 204 may simplify the hardware needed for navigation and/or the computational resources used during navigation. That is, topological-based navigation may operate with low-cost vision and/or low-cost inertial measurement unit (IMU) sensors when compared to navigation using metric localization that often requires expensive LIDAR sensors and/or expensive IMU sensors. Metric-based navigation tends to demand more computational resources than topological-based navigation because metric-based navigation often performs localization at a much higher frequency than topological navigation (e.g., with waypoints 212). For instance, the common navigation approach of Simultaneous Localization and Mapping (SLAM) using a global occupancy grid is constantly performing robot localization.

Referring to FIG. 2, the navigation generator 210 may record a plurality of waypoints 212, 212a-n on a topological map 204. From the plurality of recorded waypoints 212, the navigation generator 210 may select some number of the recorded waypoints 212 as a sequence of waypoints 212 that form the navigation route 202 for the robot 100. In some implementations, an operator of the robot 100 may use the navigation generator 210 to select or build a sequence of waypoints 212 to form the navigation route 202. In some implementations, the navigation generator 210 may generate the navigation route 202 based on receiving a destination location and a starting location for the robot 100. For instance, the navigation generator 210 may match the starting location with a nearest waypoint 212 and similarly match the destination location with a nearest waypoint 212. The navigation generator 210 may then select some number of waypoints 212 between these nearest waypoints 212 to generate the navigation route 202.

In some configurations, the navigation generator 210 may receive, e.g., as input from the mission execution system 184, a mission recording and possibly also an associated topological map 204, and, in response, may generate a navigation route 202 that includes the various waypoints 212 that are included in the mission recording, as well as intermediate waypoints 212 and edges between pairs of waypoints 212. For instance, for a mission to inspect different locations on a pipeline, the navigation generator 210 may receive a mission recording identifying waypoints 212 at which inspections are to occur as well as a topological map 204 generated during the recording process, and may generate a navigation route 202 that includes waypoints 212 that coincide with the identified inspection locations. In the example shown in FIG. 2, the navigation generator 210 has generated the navigation route 202 with a sequence of waypoints 212 that include nine waypoints 212a-i and their corresponding edges 214a-h. FIG. 2 illustrates each waypoint 212 of the navigation route 202 in a double circle, while recorded waypoints 212 that are not part of the navigation route 202 have only a single circle. As illustrated, the navigation generator 210 may then communicate the navigation route 202 to the route executor 220.

The route executor 220 may be configured to receive and to execute the navigation route 202. To execute the navigation route 202, the route executor 220 may coordinate with other systems of the robot 100 to control the locomotion-based structures of the robot 100 (e.g., the legs) to drive the robot 100 through the sequence of waypoints 212 that are included in the navigation route 202. For instance, the route executor 220 may communicate the movement instructions associated with edges 214 connecting waypoints 212 in the sequence of waypoints 212 of the navigation route 202 to the control system 170. The control system 170 may then use such movement instructions to position the robot 100 (e.g., in an orientation) according to one or more pose transformations to successfully move the robot 100 along the edges 214 of the navigation route 202.

While the robot 100 is traveling along the navigation route 202, the route executor 220 may also determine whether the robot 100 is unable to execute a particular movement instruction for a particular edge 214. For instance, the robot 100 may be unable to execute a movement instruction for an edge 214 because the robot 100 encounters an unforeseeable obstacle 20 while moving along the edge 214 to a waypoint 212. Here, the route executor 220 may recognize that an unforeseeable obstacle 20 blocks the path of the robot 100 (e.g., using real-time or near real-time sensor data 134) and may be configured to determine whether an alternative path 206 for the robot 100 exists to an untraveled waypoint 212, 212U in the sequence of the navigation route 202. An untraveled waypoint 212U refers to a waypoint 212 of the navigation route 202 to which the robot 100 has not already successfully traveled. For instance, if the robot 100 had already traveled to three waypoints 212a-c of the nine waypoints 212a-i of the navigation route 202, the route executor 220 may try to find an alternative path 206 to one or the remaining six waypoints 212d-i, if possible. In this sense, the alternative path 206 may be an obstacle avoidance path that avoids the unforeseeable obstacle 20 and also a path that allows the robot 100 to resume the navigation route 202 (e.g., toward a particular goal or task). This means that after the robot 100 travels along the alternative path 206 to a destination of an untraveled waypoint 212U, the route executor 220 may continue executing the navigation route 202 from that destination of the alternative path 206. Such an approach may enable the robot 100 to return to navigation using the sparse topological map 204.

For example, referring to FIG. 2, if the unforeseeable obstacle 20 blocks a portion of the third edge 214c (e.g., blocks some portion of the third edge 214c and the fourth waypoint 212d), the robot 100 has already traveled to three waypoints 212a—c. In such a circumstance, the route executor 220 may generate an alternative path 206, which avoids the unforeseeable obstacle 20, to the fifth waypoint 212e, which is an untraveled waypoint 212U. The robot 100 may then continue traversing the sequence of waypoints 212 for the navigation route 202 from the fifth waypoint 212e. This means that the robot 100 would then travel to the untraveled portion following the sequence of waypoints 212 for the navigation route 202 (e.g., by using the movement instructions of edges 214 of the untraveled portion). In the illustrated example, the robot 100 would thus travel from the fifth waypoint 212e to the sixth, seventh, eighth, and finally ninth waypoints 212, 212f-i, barring the detection of some other unforeseeable object 20. This means that, although the unforeseeable object 20 was present along the third edge 214c, the robot 100 only missed a single waypoint, i.e., the fourth waypoint 212d, during its movement path while executing the navigation route 202.

As noted above, some embodiments include a robot controller 188 that may be manipulated by an operator to control operation of the robot 100. In the illustrated example shown in FIG. 3A, the robot controller 188 is a computing device (e.g., a tablet computer such as a Samsung Galaxy Tab, an Apple iPad, or a Microsoft Surface) that includes a touchscreen configured to present a number of “soft” UI control elements. As illustrated in FIG. 3A, in some implementations, screen 300 may present a pair of joystick controllers 302, 304, a pair of slider controllers 306, 308, a pair of mode selection buttons 310, 312, and a camera view selector switch 314.

In some implementations, the mode selection buttons 310, 312 may allow the operator to place the robot 100 in either a non-ambulatory mode, e.g., “stand,” upon selecting the mode selection button 310, or an ambulatory mode, e.g., “walk,” upon selecting the mode selection button 312. For example, in response to selection of the mode selection button 310, the robot controller 188 may cause a first pop-up menu to be presented that allows the operator to select from amongst several operational modes that do not involve translational movement (i.e., movement in the X-Y direction) by the robot 100. Examples of such non-ambulatory modes included “sit” and “stand.” Similarly, in response to selection of the mode selection button 312, the robot controller 188 may cause a second pop-up menu to be presented that allows the operator to select from amongst several operational modes that do involve translational movement by the robot 100. Examples of such ambulatory modes include “walk,” “crawl,” and “stairs.”

In some implementations, the functionality of one or both of the joystick controller 302, 304 and/or the slider controllers 306, 308 may depend upon the operational mode that is currently selected (via the mode selection buttons 310, 312). For instance, when a non-ambulatory mode (e.g., “stand”) is selected, the joystick controller 302 may control the pitch (i.e., rotation about the X-direction axis) and the yaw (i.e., rotation about the Z-direction axis A_{z}) of the body 110 of robot 100, whereas when an ambulatory mode (e.g., walk) is selected, the joystick controller 302 may instead control the translation (i.e., movement in the X-Y plane) of the body 110 of the robot 100. The slider controller 306 may control the height of the body 110 of the robot 100, e.g., to make is stand tall or crouch down. When an ambulatory mode (e.g., walk) is selected, the slider controller 308 may control the speed of the robot 100. In some implementations, the camera selector switch 314 may control which of the robot's cameras is selected to have its output displayed on the screen 300, and the joystick controller 304 may control the pan direction of the selected camera.

The create button 316 presented on the screen 300 may, in some implementations, enable the operator of the robot controller 188 to select and invoke a process for creating a new action for the robot 100, e.g., while recording a mission. For instance, if the operator of the robot 100 wanted the robot 100 to acquire an image of a particular instrument within a facility, the operator could select the create button 316 to select and invoke a process for defining where and how the image is to be acquired. In some implementations, in response to selection of the create button 316, the robot controller 188 may present a list of actions, e.g., as a drop down or pop-up menu, that can be created for the robot 100.

FIG. 3A illustrates how the screen 300 may appear after the user has selected the create button 316 and has further selected an action to capture a thermal image using a thermal camera mounted on the robot. As shown, in some implementations, the name of the selected action may be presented in a status bar 318 on the screen 300. As also shown, the screen 300 may also present instructions 320 for implementing a selected action, as well as a first UI button 322 that may be used to specify a location at which the robot 100 is to begin performing the action, and a second UI button 324 at which the robot 100 is to cease performing the action. In the case of capturing an image during a mission, the start location and the end location of the robot may be the same, so only one of UI button 322 or UI button 324 may be displayed on screen 300.

In some embodiments, when creating an action, the user may interact with the user interface to specify additional information regarding an asset of interest in the image to associate with the image. For instance, following capture of an image, the user may interact with the user interface to define a region of interest (ROI) within the image that includes a particular asset of interest. The user may then interact with the user interface to specify asset information to include in a data structure that may be associated with the ROI and stored as metadata along with the captured image. The asset information may include an asset identifier or “asset ID,” which uniquely identifies the asset in the environment, such that data (e.g., the ROI and/or the entire image), having been associated with the asset identifier, can later be identified and compared across images, actions, and missions, as described in more detail below. In this way, use of an asset identifier to identify assets in sensor data in accordance with some embodiments decouples that sensor data from a particular action and mission from which it was recorded.

In some embodiments, the asset identifier is implemented as an alphanumeric string. The asset information included in the data structure may also include, but is not limited to, equipment class information associated with the asset, and a location in the environment at which the corresponding image was captured. In some implementations, the asset information may also include information about the pose of the robot when acquiring the image or any other suitable information. Because the asset information is associated with a particular action (e.g., capturing sensor data) of the mission recording, each time that the robot executes the mission, sensor data corresponding to that action is recorded and the asset identifier specified in the asset information and defined by the user may be automatically associated with all or a portion (e.g., an ROI) of the recorded sensor data.

In some instances, multiple assets of interest may be present in a single image captured by the robot. In such instances, the user may interact with the user interface to define multiple ROIs in the image, each of which may be associated with different asset information including a unique asset identifier as described above. In some embodiments, the same asset of interest may be included in multiple images captured, for example, at different angles and/or at different waypoints during mission recording. In such instances, the same asset identifier may be associated with all or a portion of each of the multiple images, which may improve reliability of the inspection system if, for example, one or more of the captured images shows a spurious result that should be ignored.

In embodiments in which multiple ROIs are defined for different assets (either within a single image or across multiple images), information within the multiple ROIs may be analyzed and compared to perform one or more anomaly operations. For instance, a first temperature (or other measured quantity such as radiation, vibration, sounds, pressure, etc.) of a first asset defined within a first ROI may be determined, a second temperature (or other measured quantity) of a second asset defined within a second ROI may be determined, and an alert may be generated based, at least in part, on a comparison of the first temperature and the second temperature (or other measured quantity). Such anomaly operations facilitate an analysis of the relative temperature (or other measured quantity or quantities) of assets in an environment. Although a single same measured quantity (e.g., temperature) has been used in the example provided above, it should be appreciated that more than one measured quantity (e.g., temperature and radiation) and/or different measured quantities may be determined in different ROIs for comparison and generation of alerts, in accordance with the techniques described herein.

FIGS. 3B and 3C illustrate example portions of a user interface (e.g., which may be displayed on robot controller 188) to enable a user to define a region of interest within a captured image. As shown in FIG. 3B, the user interface may be configured to display the captured image and information associated with a measured quantity (e.g., temperature) within the image. In the example of FIG. 3B, an isothermal image is shown along with information about the detected temperature within the image and within a region of interest defined by a user. The user may interact with the user interface to specify a region of interest 330 that includes an asset to be monitored. The user may also interact with the user interface to specify asset information, which may be used, for example, to generate alerts. As shown in FIG. 3B, the asset information may include a minimum and/or maximum temperature threshold when the monitored quantity is temperature.

In the example of FIG. 3C, color image is shown along with information about the detected temperature within the image and within a region of interest defined by a user. The user may interact with the user interface to specify a region of interest 340 that includes an asset to be monitored. Similar to the portion of a user interface shown in FIG. 3B, the user may also interact with the user interface shown in FIG. 3C to specify asset information, which may be used, for example, to generate alerts.

In some embodiments, the ROIs and asset information are provided by a user during recording of a mission. In other embodiments, at least some of the ROIs and/or asset information are provided by a user after completion of the mission. For instance, all images captured during the mission may be stored and later reviewed by a user, who may define the ROIs and/or provide corresponding asset information for the reviewed images or other sensor data. Regardless of when the ROIs and asset information are defined or provided by a user, they are stored with corresponding actions in the mission recording. Importantly, once the ROIs and asset information has been incorporated into the mission recording by being associated with actions of the mission, each time that the mission is executed thereafter, the definition of ROIs and assignment of asset information including unique asset identifiers on newly captured images during execution of the mission may be performed automatically (i.e., without requiring further manual intervention). In this way, a set of consistent sensor data collected over time is recorded, which may be useful for monitoring assets in an environment such as an industrial facility, assessing trends in performance and/or characteristics of the assets, and/or detecting anomalous behavior for which an alert should be generated.

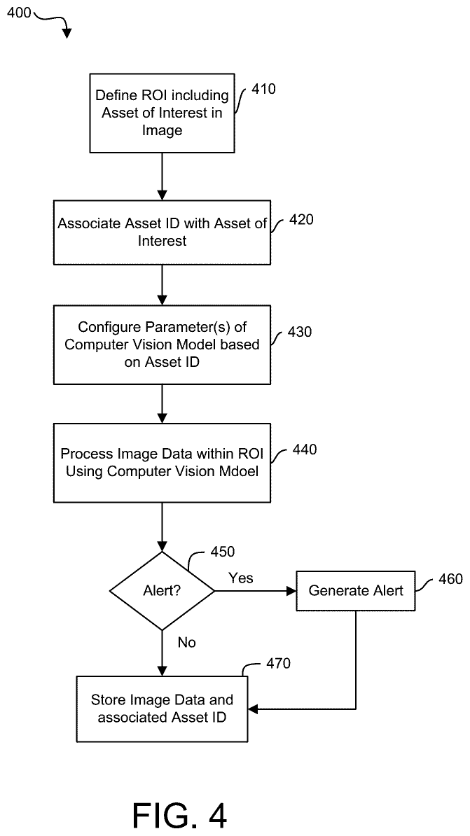

FIG. 4 is a flowchart of a process 400 for performing automated asset inspection using a mobile robot, in accordance with some embodiments. In act 410, a region of interest (ROI) is defined within an image captured by the mobile robot. As described above, the ROI may be defined based on user input provided via a user interface (e.g., screen 300) during recording of a mission. It should be appreciated, however, that the ROI in an image may alternatively be defined after completion of the mission based on an evaluation of the image captured during recording of the mission. In some implementations, an image captured during recording of a mission may include an asset of interest, but may not have an ROI defined for the image. In such implementations the entire image may be considered as the defined ROI.

Process 400 then proceeds to act 420, where an asset identifier (asset ID) is associated with the ROI defined in act 410. The asset ID may be included along with other asset information, example of which include, but are not limited to, an equipment class associated with the asset, a computer vision model to use for processing the image, and one or more parameters that may be used to configure the computer vision model to analyze the image. For instance, when the image is a thermal image, the one or more parameters may include one or more temperature thresholds used to determine whether an alert should generated, as described in more detail below. When the sensor data (e.g., an image) is configured to capture quantities other than temperature, examples of which include, but are not limited to, radiation, vibration, pressure, sound), the one or more parameters may include other relevant metrics used to generate alerts.

Process 400 then proceeds to act 430, where one or more parameters of a computer vision model are configured based on the information associated with the asset ID. In some implementations, the sensor data captured during execution of a mission includes thermal images of assets in the environment. In such implementations, the asset ID may be associated with one or more parameters specifying one or more temperature thresholds used by the computer vision model to determine whether the temperature of the asset represented in a captured thermal image is above or below the threshold(s). It should be appreciated that the one or more parameters used to configure a computer vision model in act 430 may be dependent on the type of sensor data to be analyzed and/or the type of computer vision model used. For instance, if the sensor data is a color image, the one or more parameters may include color value thresholds, if the sensor data is video data, the one or more parameters may include movement threshold information, if the sensor data is audio data, the one or more parameters may include frequency threshold information, etc. In some implementations, the information associated with an asset ID may be used to select a particular computer vision model from among a plurality of computer vision models associated with the robot. In some implementation, the information associated with an asset ID may be used to determine when sensor data should be processed with a computer vision model, e.g., during mission execution or after mission execution.

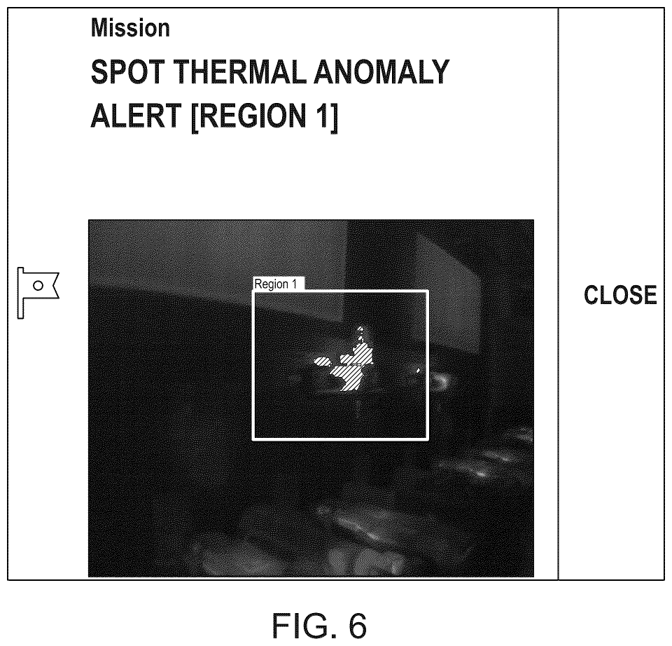

After one or more parameters of a computer vision model have been configured in act 430, process 400 proceeds to act 440, where the captured image data within an ROI is processed by the configured computer vision model to determine whether an alert should be generated. Process 400 then proceeds to act 450, where it is determined whether an alert should be generated based on the output of the computer vision model. If it is determined in act 450 that an alert should be generated (e.g., because a temperature of an asset is above a temperature threshold specified in the computer vision a model), process 400 proceeds to act 460, where the alert is generated. Non-limiting examples of generating alerts are provided with reference to FIGS. 6A-9, described in more detail below. Regardless of whether it is determined in act 450 that an alert should be generated, process 400 proceeds to act 470, where the sensor data (e.g., image data) and the associated asset ID is stored (e.g., in on-robot storage) for future analysis. As discussed above, one of the advantages of assigning asset IDs to assets in a monitored environment is that the same asset IDs can be used across actions and missions, thereby enabling an automated asset inspection system capable of monitoring assets reliably over any desired period of time.

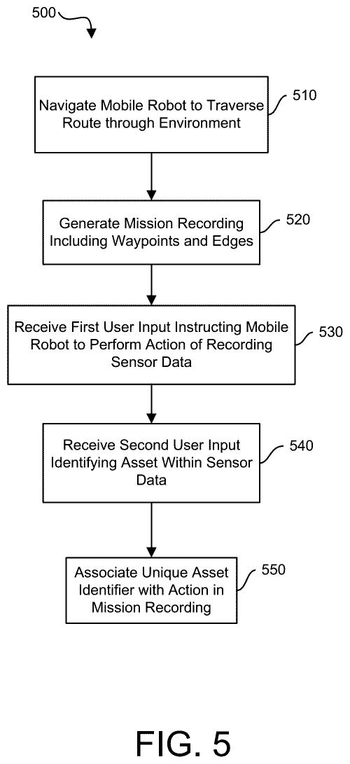

FIG. 5 illustrates a process 500 for generating a mission recording including asset identifiers in accordance with some embodiments. In act 510, a mobile robot, such as robot 100 shown in FIG. 1A, is navigated to traverse a route through an environment, such as an industrial facility. Process 500 then proceeds to act 520, where, during navigation of the robot through the environment, a mission recording including waypoints and edges is generated. As described above, the waypoints and edges of the mission recording may be generated in the background as an operator navigates the robot, such that the operator is not aware that they are being added to the mission recording. Process 500 then proceeds to act 530, where first user input instructing the mobile robot to perform an action of recording sensor data is received. Similar to the generation of waypoints and edges, the creation and subsequent association of an action with the mission recording may not be readily apparent to the operator of the robot other than the operator providing the user input via the robot controller to initiate performance of the action. In some implementations, when an action is created, a new waypoint is added to the mission recording at a location where the action was performed, such that the action is associated with the new waypoint. Process 500 then proceeds to act 540, where second user input identifying an asset within the sensor data is received via the user interface. For instance, as described herein, the recorded sensor data may be an image and the user may interact with a user interface presented on the robot controller to define an ROI within the image and associate asset information with the defined ROI. Process 500 then proceeds to act 550, where the asset information including the unique asset ID identifying the asset of interest is associated with the action in the mission recording, such that upon re-execution of the mission, the same asset information is associated with sensor data recorded when the robot performs the action at its associated waypoint along the route.

As discussed above in connection with process 400 in FIG. 4, in some implementations, after analysis of sensor data within a defined ROI by a computer vision model, it may be determined that an alert should be generated. The alert may be provided to a user in any suitable way including, but not limited to, displaying an image with the anomaly highlighted, providing the alert to a cloud service, or sending an alert via electronic messaging (e.g., email, etc.) or to another computing device (e.g., a mobile device) via an app installed on the computing device. FIG. 6 illustrates an example of providing an alert in which a captured thermal image is annotated with an overlay of a defined ROI and an indication that the temperature of the asset within the ROI is above a threshold value set for the computer vision model that analyzed the image.

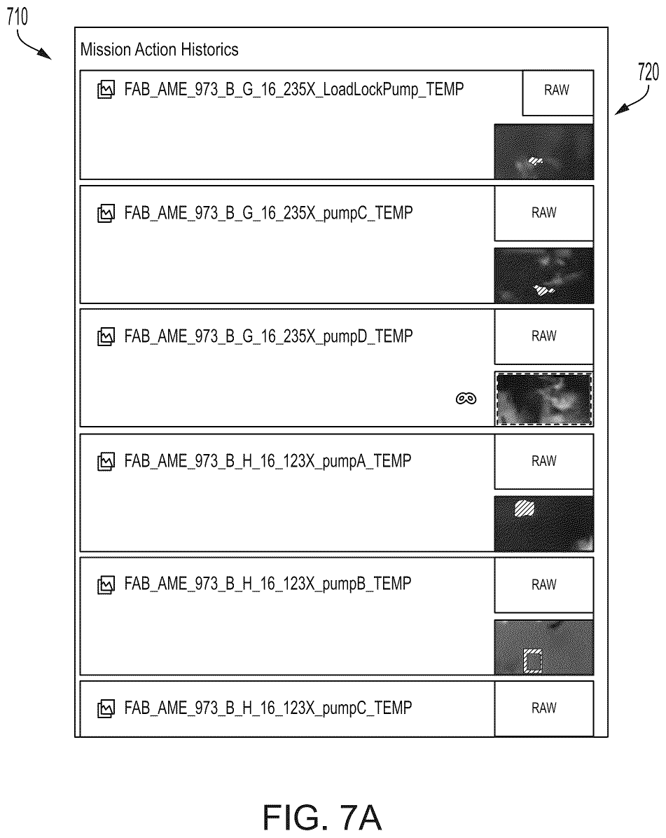

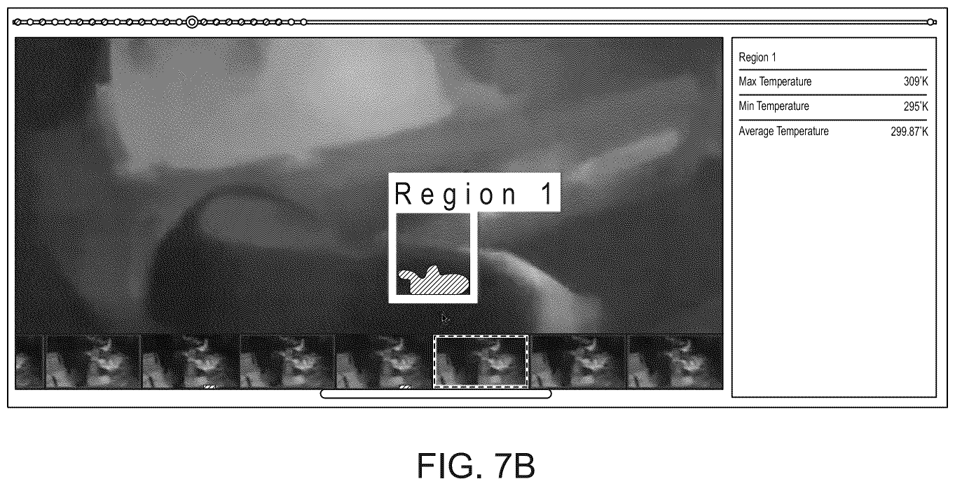

As described in connection with process 400 in FIG. 4, regardless of whether an alert is generated for a particular asset identified in recorded sensor data, in some embodiments all of the recorded sensor data and associated metadata including the asset information is stored (e.g., on a storage device associated with the robot), which enables a time-based analysis of the recorded and processed asset data in a monitored facility. FIG. 7A illustrates a portion of a user interface that shows multiple images captured during different actions and/or missions, where each of the multiple images is associated with a same asset via its unique asset ID. In the example shown in FIG. 7A, the user interface includes descriptive data 710 for each of the images and a thumbnail image 720 in which an overlay of the ROI is shown when, for example, an alert has been generated for that image. Such a user interface enables a user to view historical data corresponding to each time sensor data for the asset was captured independent of the mission and action for when particular sensor data captures occurred.

FIG. 7B illustrates another portion of a user interface in which one of the thumbnail images 720 is selected for viewing. As shown, the defined ROI in the image may be overlaid on the image and an indication of whether an alert was generated for that ROI may be displayed. Also shown in the user interface of FIG. 7B are characteristics of the asset derived from the computer vision model used to analyze the image and that were tracked across the series of image captures. For instance, as shown the maximum temperature of the asset, the minimum temperature of the asset, and the average temperature of the asset within the ROI across all images is shown. Such analysis enables long-term trend analysis of characteristics of assets in an environment, and may be used, for example, to adjust one or more parameters (e.g., thresholds) used by a computer vision model to generate alerts.

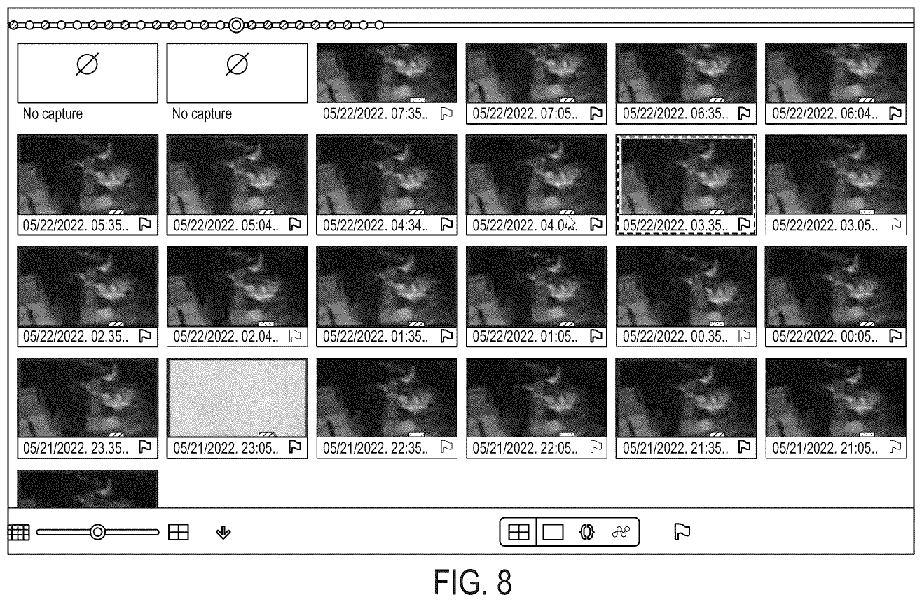

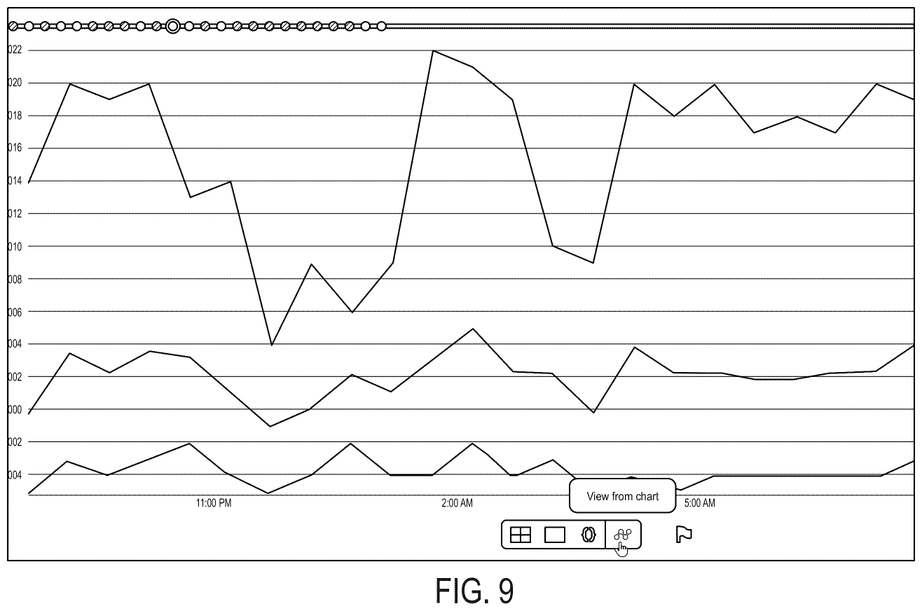

FIG. 8 shows a portion of a user interface in which images of the same view of an asset recorded across multiple executions of a mission are displayed. As shown, each of the images may be annotated with information about whether an alert was generated based on the analysis of the image using a computer vision model. FIG. 9 shows a portion of a user interface where a monitored characteristic of an asset (e.g., average temperature) is plotted as a function of time based on images captured during multiple executions of a mission. Associating each asset in a monitored environment with a unique asset identifier enables visualization of time-based trends that provides insight into the operating status of the asset without requiring manual checking of the asset as is typically required with existing inspection systems. In some embodiments, a trend analysis may be provided separately from or alongside an image displayed on user interface on which one or more alerts are shown.

In some embodiments, a trend analysis performed in accordance with the techniques described herein may be used for preventative maintenance of one or more assets in an environment. For instance, the trend analysis may reveal information that may not be readily apparent when only thresholds are used to generate alerts. As an example, the trend analysis may reveal that a particular asset or multiple assets have been gradually heating up over time and should be serviced or replaced before the asset fails. As another example, the trend analysis may reveal that an asset has experienced increased vibrations over time, which may indicate a need to service the asset to, for example, prevent damage to the asset. A trend analysis generated in accordance with the techniques described herein may be useful for other reasons not mentioned herein, and embodiments are not limited in this respect.

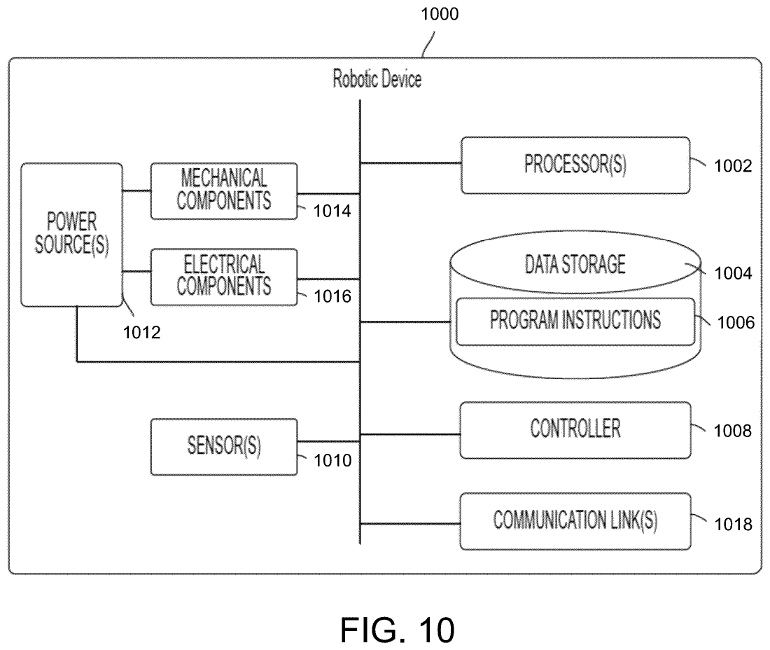

FIG. 10 illustrates an example configuration of a robotic device (or “robot”) 1000, according to some embodiments. The robotic device 1000 may, for example, correspond to the robot 100 described above. The robotic device 1000 represents an illustrative robotic device configured to perform any of the techniques described herein. The robotic device 1000 may be configured to operate autonomously, semi-autonomously, and/or using directions provided by user(s), and may exist in various forms, such as a humanoid robot, biped, quadruped, or other mobile robot, among other examples. Furthermore, the robotic device 1000 may also be referred to as a robotic system, mobile robot, or robot, among other designations.

As shown in FIG. 10, the robotic device 1000 may include processor(s) 1002, data storage 1004, program instructions 1006, controller 1008, sensor(s) 1010, power source(s) 1012, mechanical components 1014, and electrical components 1016. The robotic device 1000 is shown for illustration purposes and may include more or fewer components without departing from the scope of the disclosure herein. The various components of robotic device 1000 may be connected in any manner, including via electronic communication means, e.g., wired or wireless connections. Further, in some examples, components of the robotic device 1000 may be positioned on multiple distinct physical entities rather on a single physical entity.

The processor(s) 1002 may operate as one or more general-purpose processor or special purpose processors (e.g., digital signal processors, application specific integrated circuits, etc.). The processor(s) 1002 may, for example, correspond to the data processing hardware 142 of the robot 100 described above. The processor(s) 1002 can be configured to execute computer-readable program instructions 1006 that are stored in the data storage 1004 and are executable to provide the operations of the robotic device 1000 described herein. For instance, the program instructions 1006 may be executable to provide operations of controller 1008, where the controller 1008 may be configured to cause activation and/or deactivation of the mechanical components 1014 and the electrical components 1016. The processor(s) 1002 may operate and enable the robotic device 1000 to perform various functions, including the functions described herein.

The data storage 1004 may exist as various types of storage media, such as a memory. The data storage 1004 may, for example, correspond to the memory hardware 144 of the robot 100 described above. The data storage 1004 may include or take the form of one or more non-transitory computer-readable storage media that can be read or accessed by processor(s) 1002. The one or more computer-readable storage media can include volatile and/or non-volatile storage components, such as optical, magnetic, organic or other memory or disc storage, which can be integrated in whole or in part with processor(s) 1002. In some implementations, the data storage 1004 can be implemented using a single physical device (e.g., one optical, magnetic, organic or other memory or disc storage unit), while in other implementations, the data storage 1004 can be implemented using two or more physical devices, which may communicate electronically (e.g., via wired or wireless communication). Further, in addition to the computer-readable program instructions 1006, the data storage 1004 may include additional data such as diagnostic data, among other possibilities.

The robotic device 1000 may include at least one controller 1008, which may interface with the robotic device 1000 and may be either integral with the robotic device, or separate from the robotic device 1000. The controller 1008 may serve as a link between portions of the robotic device 1000, such as a link between mechanical components 1014 and/or electrical components 1016. In some instances, the controller 1008 may serve as an interface between the robotic device 1000 and another computing device. Furthermore, the controller 1008 may serve as an interface between the robotic system 1000 and a user(s). The controller 1008 may include various components for communicating with the robotic device 1000, including one or more joysticks or buttons, among other features. The controller 1008 may perform other operations for the robotic device 1000 as well. Other examples of controllers may exist as well.

Additionally, the robotic device 1000 may include one or more sensor(s) 1010 such as image sensors, force sensors, proximity sensors, motion sensors, load sensors, position sensors, touch sensors, depth sensors, ultrasonic range sensors, and/or infrared sensors, or combinations thereof, among other possibilities. The sensor(s) 1010 may, for example, correspond to the sensors 132 of the robot 100 described above. The sensor(s) 1010 may provide sensor data to the processor(s) 1002 to allow for appropriate interaction of the robotic system 1000 with the environment as well as monitoring of operation of the systems of the robotic device 1000. The sensor data may be used in evaluation of various factors for activation and deactivation of mechanical components 1014 and electrical components 1016 by controller 1008 and/or a computing system of the robotic device 1000.

The sensor(s) 1010 may provide information indicative of the environment of the robotic device for the controller 1008 and/or computing system to use to determine operations for the robotic device 1000. For example, the sensor(s) 1010 may capture data corresponding to the terrain of the environment or location of nearby objects, which may assist with environment recognition and navigation, etc. In an example configuration, the robotic device 1000 may include a sensor system that may include a camera, RADAR, LIDAR, time-of-flight camera, global positioning system (GPS) transceiver, and/or other sensors for capturing information of the environment of the robotic device 1000. The sensor(s) 1010 may monitor the environment in real-time and detect obstacles, elements of the terrain, weather conditions, temperature, and/or other parameters of the environment for the robotic device 1000.

Further, the robotic device 1000 may include other sensor(s) 1010 configured to receive information indicative of the state of the robotic device 1000, including sensor(s) 1010 that may monitor the state of the various components of the robotic device 1000. The sensor(s) 1010 may measure activity of systems of the robotic device 1000 and receive information based on the operation of the various features of the robotic device 1000, such as the operation of extendable legs, arms, or other mechanical and/or electrical features of the robotic device 1000. The sensor data provided by the sensors may enable the computing system of the robotic device 1000 to determine errors in operation as well as monitor overall functioning of components of the robotic device 1000.

For example, the computing system may use sensor data to determine the stability of the robotic device 1000 during operations as well as measurements related to power levels, communication activities, components that require repair, among other information. As an example configuration, the robotic device 1000 may include gyroscope(s), accelerometer(s), and/or other possible sensors to provide sensor data relating to the state of operation of the robotic device. Further, sensor(s) 1010 may also monitor the current state of a function, such as a gait, that the robotic system 1000 may currently be operating. Additionally, the sensor(s) 1010 may measure a distance between a given robotic leg of a robotic device and a center of mass of the robotic device. Other example uses for the sensor(s) 1010 may exist as well.

Additionally, the robotic device 1000 may also include one or more power source(s) 1012 configured to supply power to various components of the robotic device 1000. Among possible power systems, the robotic device 1000 may include a hydraulic system, electrical system, batteries, and/or other types of power systems. As an example illustration, the robotic device 1000 may include one or more batteries configured to provide power to components via a wired and/or wireless connection. Within examples, components of the mechanical components 1014 and electrical components 1016 may each connect to a different power source or may be powered by the same power source. Components of the robotic system 1000 may connect to multiple power sources as well.

Within example configurations, any suitable type of power source may be used to power the robotic device 1000, such as a gasoline and/or electric engine. Further, the power source(s) 1012 may charge using various types of charging, such as wired connections to an outside power source, wireless charging, combustion, or other examples. Other configurations may also be possible. Additionally, the robotic device 1000 may include a hydraulic system configured to provide power to the mechanical components 1014 using fluid power. Components of the robotic device 1000 may operate based on hydraulic fluid being transmitted throughout the hydraulic system to various hydraulic motors and hydraulic cylinders, for example. The hydraulic system of the robotic device 1000 may transfer a large amount of power through small tubes, flexible hoses, or other links between components of the robotic device 1000. Other power sources may be included within the robotic device 1000.

Mechanical components 1014 can represent hardware of the robotic system 1000 that may enable the robotic device 1000 to operate and perform physical functions. As a few examples, the robotic device 1000 may include actuator(s), extendable leg(s) (“legs”), arm(s), wheel(s), one or multiple structured bodies for housing the computing system or other components, and/or other mechanical components. The mechanical components 1014 may depend on the design of the robotic device 1000 and may also be based on the functions and/or tasks the robotic device 1000 may be configured to perform. As such, depending on the operation and functions of the robotic device 1000, different mechanical components 1014 may be available for the robotic device 1000 to utilize. In some examples, the robotic device 1000 may be configured to add and/or remove mechanical components 1014, which may involve assistance from a user and/or other robotic device. For example, the robotic device 1000 may be initially configured with four legs, but may be altered by a user or the robotic device 1000 to remove two of the four legs to operate as a biped. Other examples of mechanical components 1014 may be included.

The electrical components 1016 may include various components capable of processing, transferring, providing electrical charge or electric signals, for example. Among possible examples, the electrical components 1016 may include electrical wires, circuitry, and/or wireless communication transmitters and receivers to enable operations of the robotic device 1000. The electrical components 1016 may interwork with the mechanical components 1014 to enable the robotic device 1000 to perform various operations. The electrical components 1016 may be configured to provide power from the power source(s) 1012 to the various mechanical components 1014, for example. Further, the robotic device 1000 may include electric motors. Other examples of electrical components 1016 may exist as well.

In some implementations, the robotic device 1000 may also include communication link(s) 1018 configured to send and/or receive information. The communication link(s) 1018 may transmit data indicating the state of the various components of the robotic device 1000. For example, information read in by sensor(s) 1010 may be transmitted via the communication link(s) 1018 to a separate device. Other diagnostic information indicating the integrity or health of the power source(s) 1012, mechanical components 1014, electrical components 1018, processor(s) 1002, data storage 1004, and/or controller 1008 may be transmitted via the communication link(s) 1018 to an external communication device.

In some implementations, the robotic device 1000 may receive information at the communication link(s) 1018 that is processed by the processor(s) 1002. The received information may indicate data that is accessible by the processor(s) 1002 during execution of the program instructions 1006, for example. Further, the received information may change aspects of the controller 1008 that may affect the behavior of the mechanical components 1014 or the electrical components 1016. In some cases, the received information indicates a query requesting a particular piece of information (e.g., the operational state of one or more of the components of the robotic device 1000), and the processor(s) 1002 may subsequently transmit that particular piece of information back out the communication link(s) 1018.

In some cases, the communication link(s) 1018 include a wired connection. The robotic device 1000 may include one or more ports to interface the communication link(s) 1018 to an external device. The communication link(s) 1018 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-described functions. The one or more controllers can be implemented in numerous ways, such as with dedicated hardware or with one or more processors programmed using microcode or software to perform the functions recited above.

Various aspects of the present technology may be used alone, in combination, or in a variety of arrangements not specifically described in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, some embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments in detail, various modifications and improvements will readily occur to those skilled in the art. Such modifications and improvements are intended to be within the spirit and scope of the technology. Accordingly, the foregoing description is by way of example only, and is not intended as limiting.

What is claimed is:

1. A method, comprising:
defining, within an image captured by a sensor of a robot, a region of interest that includes an asset in an environment of the robot, wherein the asset is associated with an asset identifier;
configuring at least one parameter of a computer vision model based on the asset identifier;
processing image data within the region of interest using the computer vision model to determine whether an alert should be generated; and
outputting the alert when it is determined that the alert should be generated.

2. The method of claim 1, wherein defining the region of interest comprises defining the region of interest using asset information stored in a data structure associated with a mission recording.

3. The method of claim 2, wherein
the data structure is associated with an action of capturing the image at a first waypoint indicated in the mission recording, and
the asset identifier is included in the data structure.

4. The method of claim 2, wherein the data structure includes the at least one parameter of the computer vision model.

5. The method of claim 1, wherein the image captured by the sensor of the robot is a thermal image.

6. The method of claim 5, wherein the at least one parameter of the computer vision model comprises a temperature threshold.

7. The method of claim 6, wherein processing image data within the region of interest using the computer vision model to determine whether an alert should be generated comprises:
determining a temperature of the asset based on an analysis of the thermal image within the region of interest;
comparing the determined temperature of the asset to the temperature threshold; and
determining to generate an alert when the determined temperature meets or exceeds the temperature threshold.

8. The method of claim 1, wherein the at least one parameter of the computer vision model comprises one or more of a pressure threshold, a vibration threshold, or a radiation threshold.

9. The method of claim 1, wherein outputting the alert comprises displaying a representation of the image annotated with an indication of the alert on a display.

10. The method of claim 1, wherein outputting the alert comprises sending a message via at least one network to a computing device, the message including the alert.

11. The method of claim 1, further comprising:
storing, on at least one storage device, the image and metadata indicating the asset identifier.

12. The method of claim 1, wherein the region of interest is a first region of interest that includes a first asset, the method further comprising:
defining, within the image, a second region of interest that includes a second asset in the environment of the robot,
wherein processing image data within the region of interest using the computer vision model to determine whether the alert should be generated, comprises:
processing image data within the first region of interest using the computer vision model to determine a first result;
processing image data within the second region of interest using the computer vision model to determine a second result; and
determining whether the alert should be generated based, at least in part, on the first result and the second result.

13. The method of claim 1, further comprising:
for each of a plurality of images captured over time and having the region of interest defined therein, processing image data for the image within the region of interest using the computer vision model to determine at least one quantity associated with the asset; and
generating, based on the determined at least one quantity associated with the asset for the plurality of images, a trend analysis for the at least one quantity.

14. The method of claim 13, wherein the at least one quantity includes one or more of a temperature, a pressure, a vibration, and a radiation amount.

15. The method of claim 13, further comprising:
providing on a user interface, an indication of the trend analysis for the at least one quantity.

16. The method of claim 14, further comprising:
generating the alert based, at least in part, on the trend analysis.

17. A robot, comprising:
a perception system including an image sensor configured to capture an image; and
at least one computer processor configured to:
define, within an image captured by the image sensor, a region of interest that includes an asset in an environment of the robot, wherein the asset is associated with an asset identifier;
configure at least one parameter of a computer vision model based on the asset identifier;
process image data within the region of interest using the computer vision model to determine whether an alert should be generated; and
output the alert when it is determined that the alert should be generated.

18-27. (canceled)

28. The robot of claim 17, wherein the region of interest is a first region of interest that includes a first asset, wherein the at least one computer processor is further configured to:
define, within the image, a second region of interest that includes a second asset in the environment of the robot,
wherein processing image data within the region of interest using the computer vision model to determine whether the alert should be generated, comprises:
processing image data within the first region of interest using the computer vision model to determine a first result;
processing image data within the second region of interest using the computer vision model to determine a second result; and
determining whether the alert should be generated based, at least in part, on the first result and the second result.

29. The robot of claim 17, wherein the at least one computer processor is further configured to:
for each of a plurality of images captured over time and having the region of interest defined therein, process image data for the image within the region of interest using the computer vision model to determine at least one quantity associated with the asset; and
generate, based on the determined at least one quantity associated with the asset for the plurality of images, a trend analysis for the at least one quantity.

30-32. (canceled)

33. A non-transitory computer readable medium encoded with a plurality of instructions that, when executed by at least one computer processor perform a method, the method comprising:
defining, within an image captured by a sensor of a robot, a region of interest that includes an asset in an environment of the robot, wherein the asset is associated with an asset identifier;
configuring at least one parameter of a computer vision model based on the asset identifier;
processing image data within the region of interest using the computer vision model to determine whether an alert should be generated; and
outputting the alert when it is determined that the alert should be generated.

34-76. (canceled)
